(19) United States
(12) Patent Application Publication
(10) Pub. No.: US 2017/0098183 A1
(43) Pub. Date: Apr. 6, 2017

(54) SYSTEM AND METHOD FOR VEHICLE SALES MANAGEMENT

(71) Applicant: THE REYNOLDS AND REYNOLDS COMPANY, Kettering, OH (US)

(72) Inventors: Robert BROCKMAN, Houston, TX (US); Sidney HAIDER, Houston, TX (US)

(21) Appl. No.: 15/287,595

(22) Filed: Oct. 6, 2016

Related U.S. Application Data
(60) Provisional application No. 62/237,936, filed on Oct. 6, 2015.

(51) Int. Cl. G06Q 10/06; G06Q 30/02; G06Q 30/06

(52) U.S. Cl. CPC G06Q 10/063114; G06Q 30/0627; G06Q 30/0278

(57) ABSTRACT

A method includes supplying a mobile computing device to a vehicle salesperson, checking in to a mobile showroom, wherein checking in to a mobile showroom makes available the vehicle salesperson for ups, and determining if the vehicle salesperson is assigned an up.

### CROSS REFERENCE TO RELATED APPLICATIONS

This application is a nonprovisional application which claims priority from U.S. provisional application No. 62/237,936, filed Oct. 6, 2015, which is incorporated by reference herein in its entirety.

### TECHNICAL FIELD

Field of the Disclosure

The present disclosure relates generally to computerized systems and methods for vehicle sales management.

### Background of the Disclosure

Traditionally, a vehicle salesperson's job responsibility is to sell vehicles from prospects provided by retailer. These prospects may be retailer walk-ins, interne leads, or previous customers. Selling a vehicle to a customer physically present in the retailer may include greeting the customer, determining the customer's vehicle and vehicle purchasing needs, assisting the customer in selecting the vehicle, potentially test driving the vehicle, drafting documents for negotiations, negotiating price and financing terms, and closing the deal. Salespersons may assist in some or all of these tasks. In addition, vehicle salespersons may need to follow-up with customers on vehicle sales, make prospecting calls, and assist in trade appraisals and vehicle delivery. Low-performing salespersons and new salespersons may need assistance in particular with determining the customer's vehicle and vehicle purchasing needs, assisting the customer in selecting the vehicle, assisting the customer during a test drive of the vehicle, making prospecting calls and following up with customers. Traditionally, attempts to improve the performance of low-performing salespersons is accomplished by training by the retailer or third-party consultants.

Traditional methods in assisting vehicle salespersons are deficient. For example, following-up with customers on vehicle sales, making prospecting calls, and assisting in trade appraisals and vehicle delivery conventionally required a salesperson to remain at his desk. Training manuals and third party consultant trainers are not available to the salesperson when he is with the customer attempting to sell the vehicle. Metrics on salesperson performance may not be readily available to the salesperson, particularly while on the vehicle lot interfacing with potential customer. Assigning which salesperson may be responsible for which potential customer is deficient in traditional methods as well. In addition, management of salespersons by the retailer, particularly in assuring that salespersons follow established retailer procedures regarding interface with potential customers, adhering to test drive routes, and time management, cannot be readily performed with traditional methods.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of a portion of a mobile showroom process consistent with at least one embodiment of the present disclosure.

FIG. 2 is a block diagram of a portion of a mobile showroom process consistent with at least one embodiment of the present disclosure.

FIG. 3 is a block diagram of a portion of a mobile showroom process consistent with at least one embodiment of the present disclosure.

FIG. 4 is a block diagram of a portion of a mobile showroom process consistent with at least one embodiment of the present disclosure.

FIG. 5 is a block diagram of a portion of a mobile showroom consistent with at least one embodiment of the present disclosure.

FIG. 6 is depiction of a login graphical user interface (“GUI”) consistent with at least one embodiment of the present disclosure.

FIG. 7 is a depiction of a shot clock GUI 820 consistent with at least one embodiment of the present disclosure

FIG. 8 is a depiction of a Check-in/Out GUI consistent with at least one embodiment of the present disclosure.

FIG. 9 is depiction of an ups GUI consistent with at least one embodiment of the present disclosure.

FIG. 10 is a depiction of a notifications GUI consistent with at least one embodiment of the present disclosure.

FIG. 11 is depiction of a motivation board consistent with at least one embodiment of the present disclosure.

FIG. 12 is depiction of a daily workplan GUI consistent with at least one embodiment of the present disclosure.

FIG. 13 is a storyboard depiction of CRM processes consistent with at least one embodiment of the present disclosure.

FIG. 14 is a depiction of a select make GUI consistent with at least one embodiment of the present disclosure.

FIG. 15 is a depiction of a select model GUI consistent with at least one embodiment of the present disclosure.

FIG. 16 is depiction of a selected vehicle search GUI consistent with at least one embodiment of the present disclosure.

FIG. 16A is a depiction of a specific vehicle display GUI consistent with at least one embodiment of the present disclosure.

FIG. 17 is a depiction of a view of similar vehicles in stock GUI consistent with at least one embodiment of the present disclosure.

FIG. 18 is a depiction of a competitive comparison GUI consistent with at least one embodiment of the present disclosure.

FIG. 19 is a storyboard depiction of receive lead from the customer processes consistent with at least one embodiment of the present disclosure.

FIG. 20 is a depiction of a find customer GUI consistent with at least one embodiment of the present disclosure.

FIG. 21 is a depiction of a return customer results GUI consistent with at least one embodiment of the present disclosure.

FIG. 22 is a depiction of an add new prospect GUI consistent with at least one embodiment of the present disclosure.

FIG. 23 is a storyboard depiction of physical meet and greet processes consistent with at least one embodiment of the present disclosure.

FIG. 24 is a depiction of a needs analysis GUI consistent with at least one embodiment of the present disclosure.

FIG. 25 is a storyboard depiction of needs analysis processes consistent with at least one embodiment of the present disclosure.

FIG. 26 is a depiction of a search accessories GUI consistent with at least one embodiment of the present disclosure.

FIG. 27 is a depiction of a search accessories GUI consistent with at least one embodiment of the present disclosure.

FIG. 28 is a depiction of a walkaround highlights GUI consistent with at least one embodiment of the present disclosure.

FIG. 29 is a depiction of a walkaround highlights GUI consistent with at least one embodiment of the present disclosure.

FIG. 30 is a storyboard depiction of a vehicle walkaround process consistent with at least one embodiment of the present disclosure.

FIG. 31 is a depiction of a demo drive highlights GUI consistent with at least one embodiment of the present disclosure.

FIG. 32 is a depication of a demo drive highlights GUI consistent with at least one embodiment of the present disclosure.

FIG. 33 is a depiction of an update customer profile GUI consistent with at least one embodiment of the present disclosure.

FIG. 34 is a depiction of a customer demographics GUI consistent with at least one embodiment of the present disclosure.

FIG. 35 is a depiction of a customer demo notes GUI consistent with at least one embodiment of the present disclosure.

FIG. 36 is a depiction of a demo drive license capture GUI consistent with at least one embodiment of the present disclosure.

FIG. 37 is a depiction of a test drive route GUI consistent with at least one embodiment of the present disclosure.

FIG. 38 is a storyboard depiction of the demo drive processes consistent with at least one embodiment of the present disclosure.

FIG. 39 is a depiction of a basic appraisal GUI consistent with at least one embodiment of the present disclosure.

FIG. 40 is a depiction of a features appraisal GUI consistent with at least one embodiment of the present disclosure.

FIG. 41 is a depiction of an appraisal notes GUI consistent with at least one embodiment of the present disclosure.

FIG. 42 is a storyboard depiction of a trade appraisal process consistent with at least one embodiment of the present disclosure.

FIG. 43 is a depiction of a service virtual tour GUI consistent with at least one embodiment of the present disclosure.

FIG. 44 is a depiction of a first service appointment GUI consistent with at least one embodiment of the present disclosure.

FIG. 45 is a depiction of a delivery checklist GUI consistent with at least one embodiment of the present disclosure.

FIG. 46 is a storyboard depiction of post desking and/or F&I processes consistent with at least one embodiment of the present disclosure.

FIG. 47 is a depiction of a display manager dashboard consistent with at least one embodiment of the present disclosure.

FIG. 48 is a depiction of a manager dashboard GUI consistent with at least one embodiment of the present disclosure.

FIG. 49 is a depiction of a salesperson pop-up GUI consistent with at least one embodiment of the present disclosure.

FIG. 50 is a depiction of a message pop-up GUI consistent with at least one embodiment of the present disclosure.

### SUMMARY

A method is disclosed. The method includes supplying a mobile computing device to a vehicle salesperson, checking in to a mobile showroom, wherein checking in to a mobile showroom makes available the vehicle salesperson for ups, and determining if the vehicle salesperson is assigned an up.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As used herein, a “GUI” is a graphical user interface in which data may be displayed and entered. In certain non-limiting embodiments, the GUIs described below may be customized depending on the device on which they are displayed. In certain embodiments, information presented by GUIs may be input into the GUI or transmitted to a GUI from a remote server, accessed through a local or wide area network, such as the internet. The remote server may be any computing device, including a mobile device or computer. The remote server may include one or more databases with information stored on a non-transitory computer readable medium for use with the mobile showroom. Information input into a GUI may be transmitted to the same or a different remote server.

As used herein, “online” means connected to another computer through a network. Network includes, but is not limited to, the internet.

As used herein, “salesperson” refers to an employee of a retailer.

As used herein, “retailer” refers to any seller of vehicles, with a physical presence, such as having a car lot, or a virtual presence, such as a website, or a combination thereof.

Certain embodiments of the present disclosure relate to systems and methods that facilitate a salesperson's mobility, while still completing tasks that previously may have required the salesperson to work from a desktop computer. In these embodiments, the systems and processes described hereinafter, i.e., the mobile showroom, may be located or accessible via a mobile computing device, including, but not limited to, a smartphone, personal digital assistant, tablet computers, or wearable computers. Through access via mobile computing device to the systems and processes described hereinafter, a salesperson may, in certain embodiments, get customers and set appointments, accomplish tasks from a daily work plan, make prospecting calls, and train to sharpen knowledge and skills, while away from a desktop computer such as on a retailer car lot. Certain functionality of the mobile showroom may be contained in the mobile computing device. Other functionality may be accessible by the mobile computing device over a network, such as a local area network or the internet, from a separate computing device, such as a server. Instructions for performing the steps of the processes described herein with respect to the mobile showroom may be executed through an application, such as on a mobile computing device, or be resident on the computing device, such as a server, desktop computer or laptop computer on a non-transitory computer readable medium.

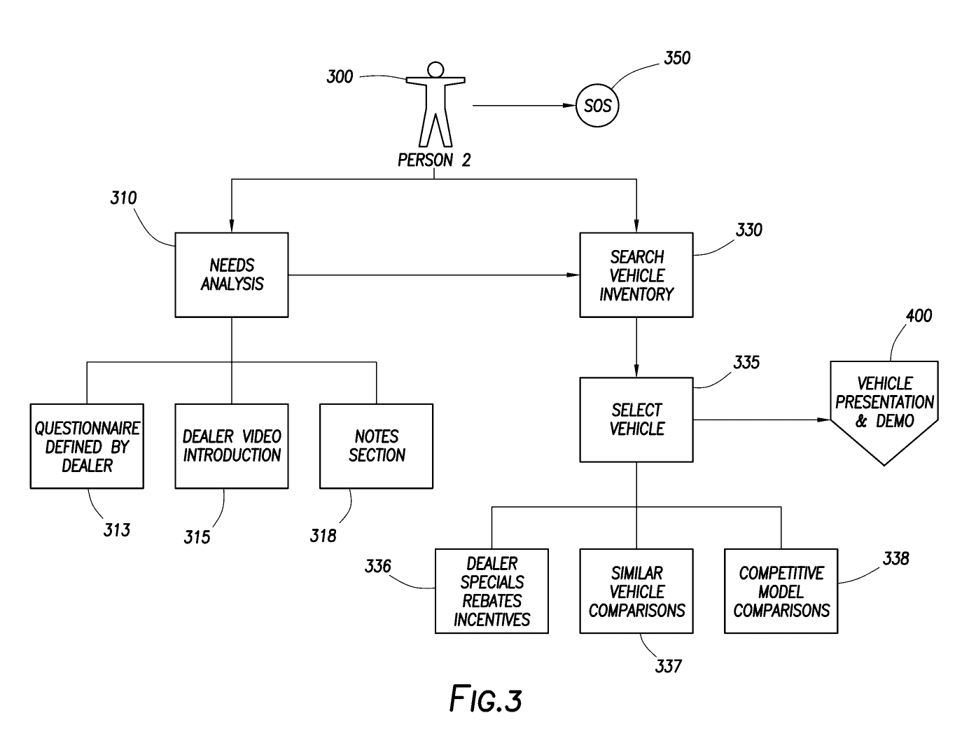

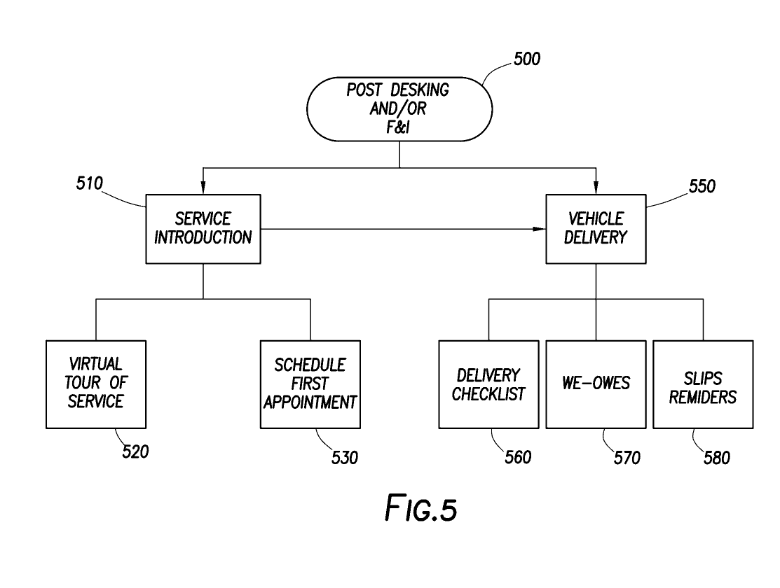

FIG. 6 depicts login GUI 800 consistent with at least one embodiment of the present disclosure. In the embodiment depicted in FIG. 3, login GUI 800 allows the salesperson to enter the salesperson's user name (801), password (802), to login to the mobile showroom. After entering the information requested by login GUI 800, the salesperson may login to the mobile showroom, such as, in the embodiment depicted in FIG. 6, by selecting login interface 805.

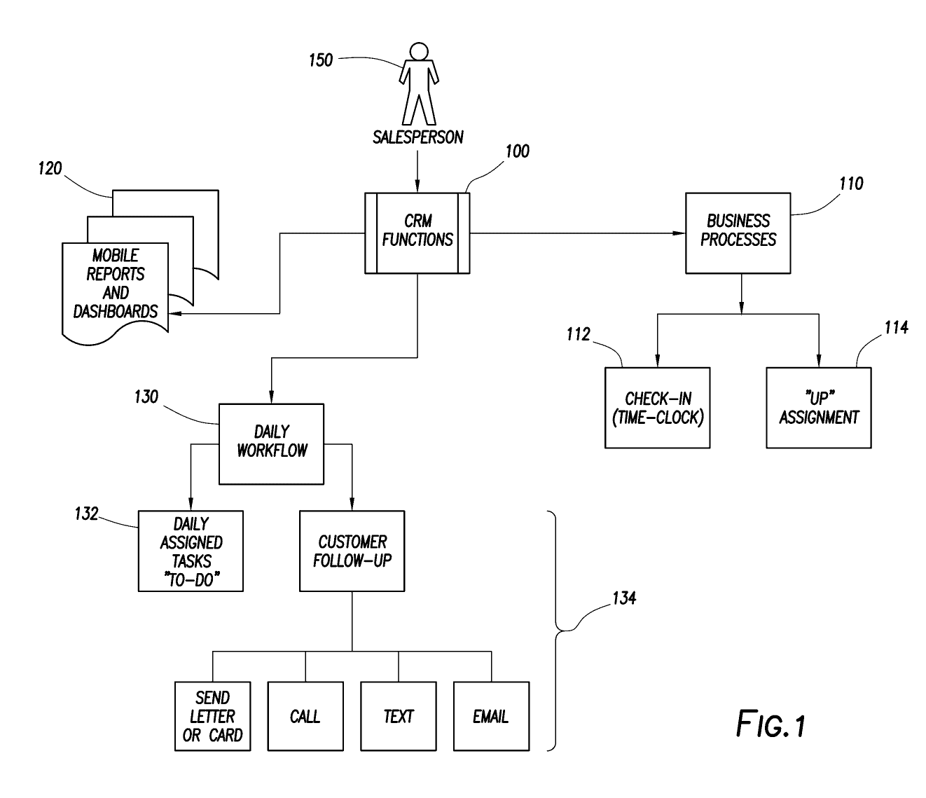

FIG. 1 is a block diagram of Customer Relationship Management (CRM) functions 100 available to salesperson 150 from the mobile computing device in mobile showroom after login. CRM processes include, but are not limited to, business processes 110, mobile reports and dashboards 120, and daily workflow 130.

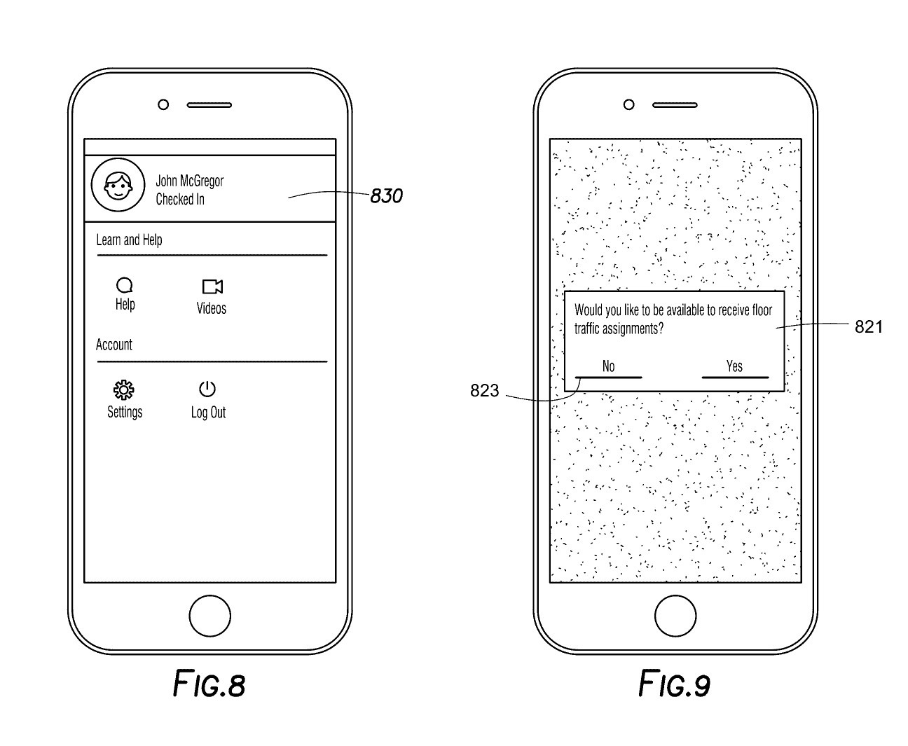

Business processes 110 may include processes related to check-in 112, which is whether the salesperson is checked into the mobile showroom, and “Up” assignment 114. In certain embodiments, logging-in to the mobile showroom is equivalent to checking-in to the mobile showroom. In other embodiments, the salesperson may check-in or out from the mobile showroom, as shown in Check-in/Out GUI 830 in FIG. 8. In certain embodiments of the present disclosure, if the status of the salesperson is “OUT,” the salesperson may not be available for floor assignments or “ups.” For purposes of this disclosure, ups are defined as potential customers or prospects. When a salesperson is not available for ups, a potential customer, such as walk-in customer to the retailer, would be assigned to another salesperson who is available for ups. The salesperson may indicate his availability for ups through ups GUI 821 through ups status entry fields 823, as shown in FIG. 9.

In certain other embodiments for the status of the salesperson to be “IN,” the salesperson must be checked in to the mobile showroom and be within a certain geographical area. In certain embodiments, mobile showroom may verify that the salesperson is within a certain geographical area, by, for instance, verifying that the salesperson is checked in through the mobile computing device to a retailer local area network. In other embodiments, mobile showroom may verify that the salesperson is within a certain geographical area by determining the GPS location of the mobile computing device, such as through a check-in request.

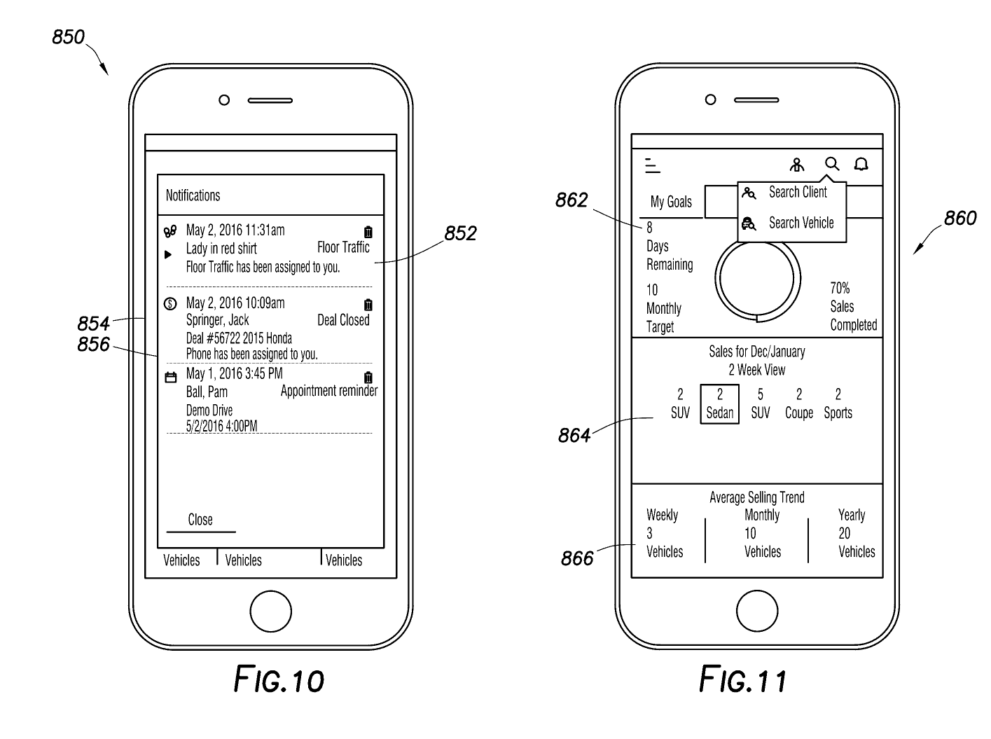

The mobile computing device may alert the salesperson that he has been assigned an up, such as a showroom guest, through notifications GUI 850. As shown in FIG. 10, up notification 852 may include such information on the salesperson's showroom guests as the showroom guest's name, if available, and any distinguishing characteristics about the showroom guest that may have been previously input to the mobile showroom or to a database that communicates with mobile showroom. Notifications GUI 850 may also provide notifications to the salesperson such as deal assignment 854 and appointment reminders 856.

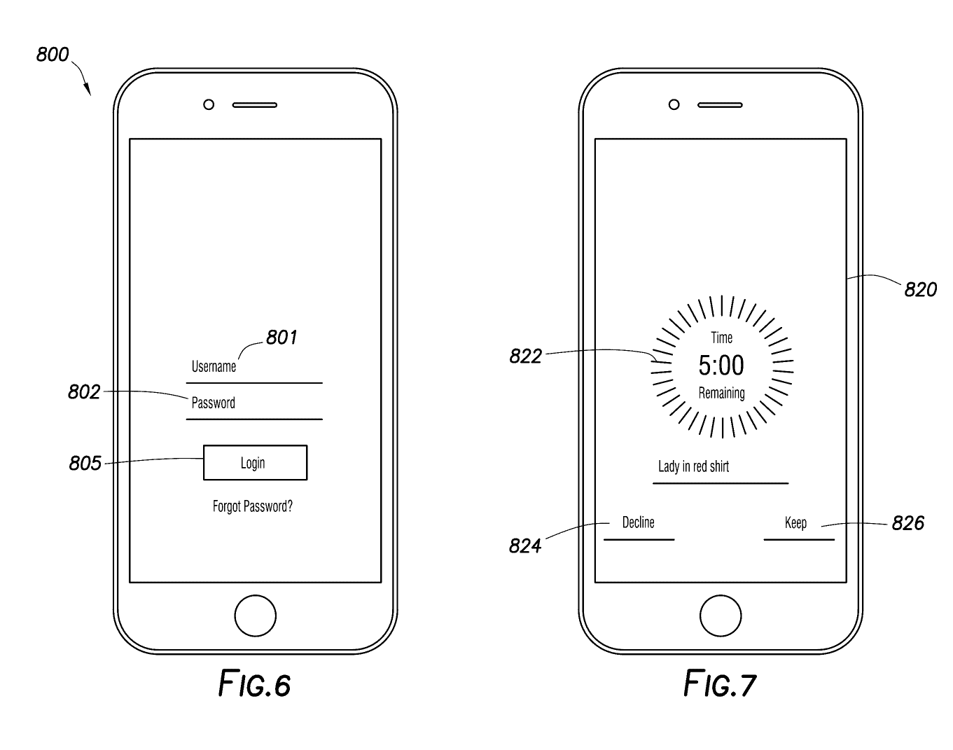

In certain embodiments, after receiving an up notification, the salesperson may have a limited time period in which to accept the up. In such embodiments, the mobile computing device may display shot clock GUI 820 as depicted in FIG. 7. Shot clock GUI 820 may depict time remaining on the shot clock on shot clock indicator 822. The salesperson may keep or decline the up through accept and decline entry fields 826, 824. If the salesperson does not indicate or select “keep” the up within the limited time period, the up may be assigned to a different salesperson.

Business processes 110 may include processes related to up assignment to salespersons. Specifically, business processes 110 of the mobile showroom may include a rules engine to determine salesperson eligibility and priority to be assigned the next up. The rules engine may consider such factors as check-in time, ranking of the salesperson (such as a ranking of the salesperson's skills or effectiveness by a retailer manager) and ineligibility due to incomplete tasks. In some embodiments, ups may be assigned through a round-robin system, whereby the rules engine includes a list of salespersons and assigns ups in order of the salespersons on the list.

CRM processes 100 may further include mobile reports and dashboards 120. Mobile reports and dashboards 120 includes graphical depictions on the mobile computing device of information which may be displayed through a reports and dashboard GUI related to salesperson performance. A non-limiting example of such a dashboard may be a sales motivation board, which may show the salesperson how the salesperson ranks compared to other salespersons with respect to vehicle sales, together with weekly or monthly goals for the salesperson and the salesperson's progress towards those goals. An example of such a dashboard is shown in FIG. 11 as motivation board 860. For example, motivation board 860 may include sales goals 862, current sales 864, and sales trends 866. Other reports and dashboards may include display of completion of activities and tasks, such as those assigned in the daily workplan, described below, sales, closing ratios, and commissions.

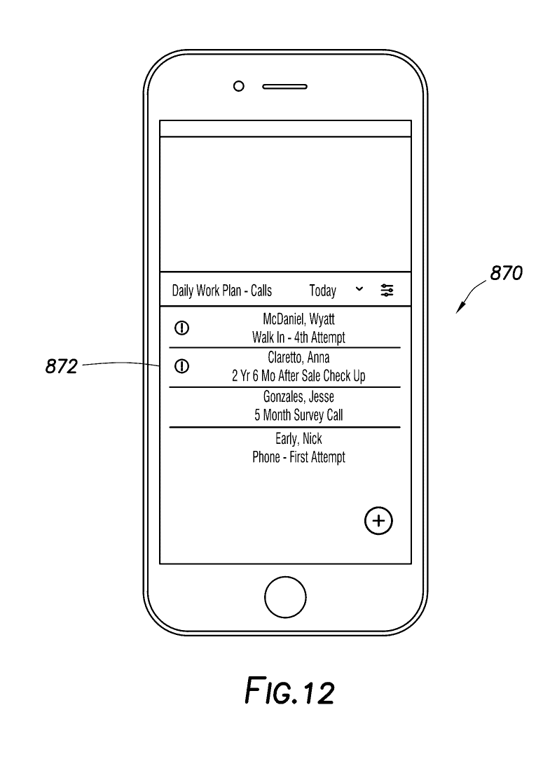

CRM processes 100 may further include daily workflow 130 as shown in FIG. 1. Daily workflow 130 may include tasks that are assigned to the salesperson such as by retailer management or through a system for managing prospects, such as that described in U.S. patent application Ser. No. 62/092,067, filed Dec. 15, 2014. The mobile showroom may access the system for managing prospects and display assigned tasks, such as through daily workplan GUI 870 as shown in FIG. 12. Daily workplan GUI 870 depicts calls 872 assigned in the daily workplan. Other daily workplan items that may be accessible through daily workplan GUI 870 may include, but not be limited to, emails, to-do items, overdue items, and prospects follow-up. FIG. 1 reflects the daily workplan functionality of mobile showroom in daily assigned tasks 132. Certain of the tasks assigned to the salesperson in daily assigned tasks 132 may include contact with existing customers, shown as customer follow-up 134. Such follow-up may include contact with customers through sending a letter or card, calling, e-mailing or texting, as shown in customer follow-up 134.

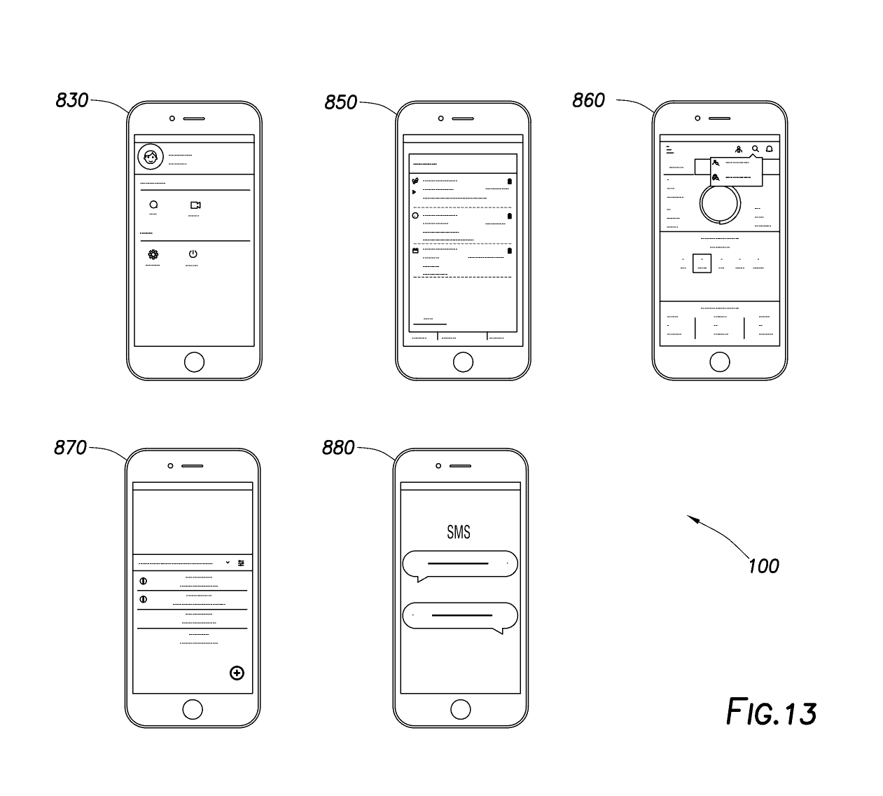

FIG. 13 is a storyboard depiction of CRM processes 100. The salesperson may use Check-in/Out GUI 830 to check-in to mobile showroom. The salesperson may be notified of assignment of an up through notifications GUI 850. Salespersons may use motivation board 860 to keep track of progress towards goals and daily workplan GUI 870 to monitor tasks. Customer follow up 134 is depicted in texting function GUI 880.

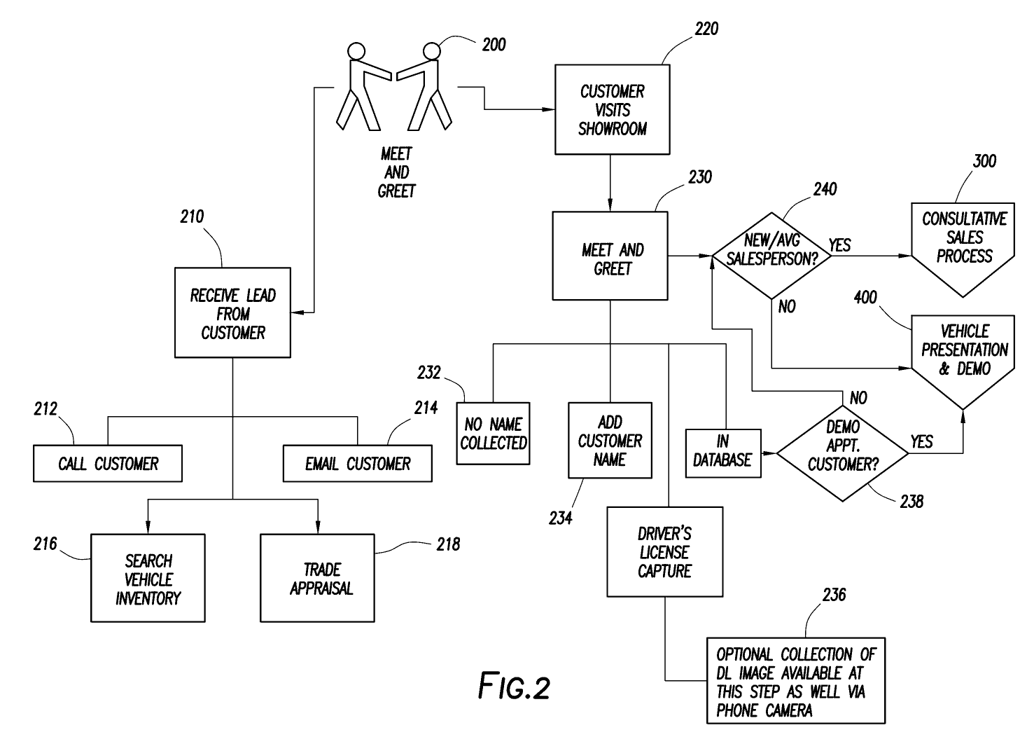

FIG. 2 is a block diagram of meet and greet processes 200. Meet and greet processes 200 may include receive lead from customer processes 210 and customer visits showroom processes 220.

In receive lead from customer processes 210, the salesperson may follow-up on a lead from the customer that is sent through mobile showroom to the mobile computing device of the salesperson by, for instance, calling the customer lead 212 or emailing the customer lead 214. Other functions in receive lead from customer processes 210 may include search vehicle inventory 216, by which a salesperson assists the customer by determining which vehicles the retailer may have in inventory that may correspond to a request by the customer, and trade appraisal 218, by which a salesperson assists the customer by appraising the customer's potential trade-in vehicle.

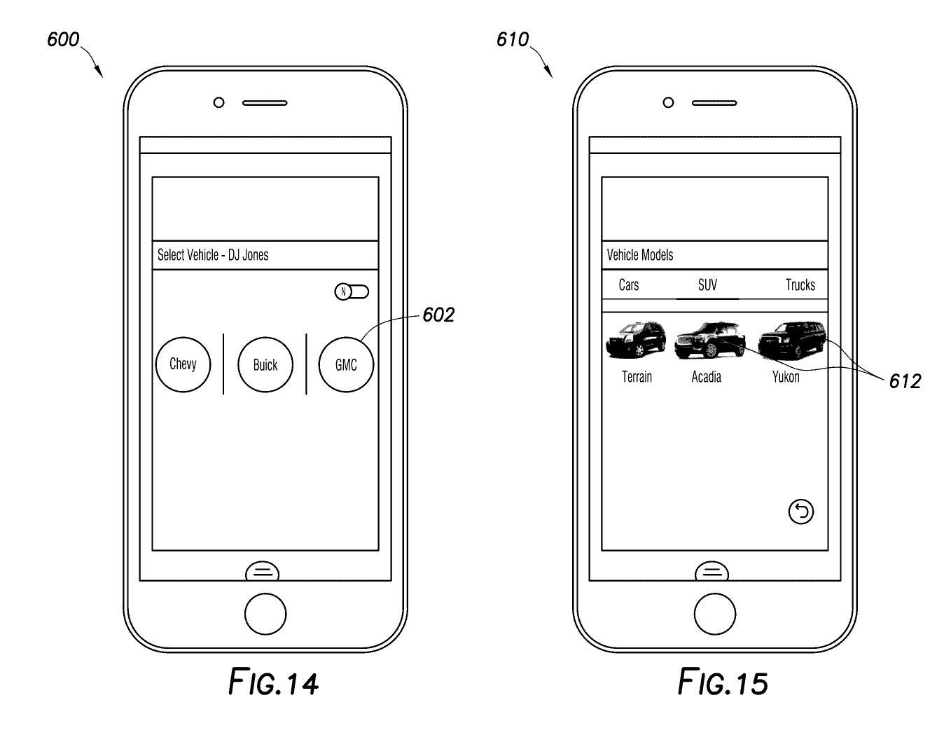

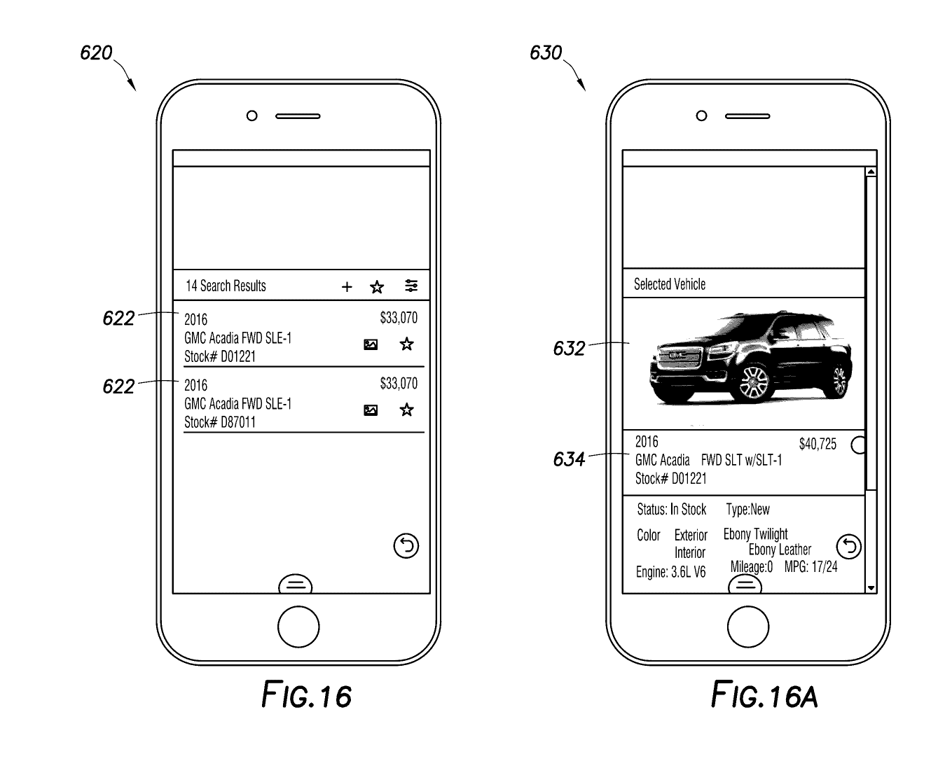

In certain embodiments, the salesperson may desire to search retailer inventory. As shown in FIGS. 14-16A, the salesperson may search retailer inventory through vehicle select GUIs 600, 610, 620, 630. Based on the information entered by the salesperson into vehicle select GUIs 600, 610, 620, 630, the mobile showroom may query a vehicle inventory database. In an embodiment, in select make GUI 600, make buttons 602 may be selected to search vehicle inventory by make as shown in FIG. 14. Following selection of the vehicle make, vehicle model may be selected through select model GUI 610 through model buttons 612 as shown in FIG. 15. By selection of vehicle make and model, search results of the retailer inventory may be displayed in selected vehicle search GUI 620, as shown by search results buttons 622 in FIG. 16. By selecting one of search results buttons 622, specific vehicle information may be displayed in specific vehicle display GUI 630, as shown in FIG. 16A. FIG. 16A may include an image of the specific vehicle (vehicle image 632) and information regarding the specific vehicle (vehicle information 634).

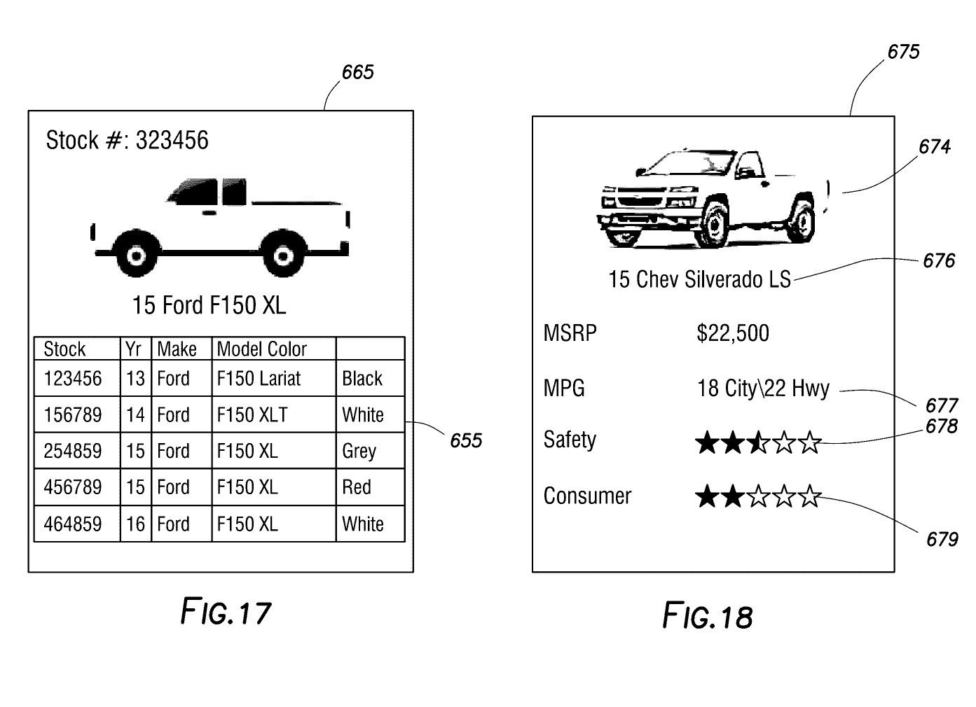

In certain embodiments, such as when the customer may desire to view other vehicles the retailer may have in inventory that may share common characteristics with the specific vehicle selected, the salesperson may further query the vehicle inventory database. In these embodiments, the salesperson may select similar in stock vehicles 655 on view similar vehicles in stock GUI 665, as shown in FIG. 17. By selecting stock vehicle 655, the salesperson may view vehicle information as listed above for specific vehicle display GUI 630 with respect to stock vehicle 655. In some embodiments, the customer may desire to view vehicles competitive with search results of the retailer inventory. As shown in FIG. 18, the competitive vehicle may be displayed on competitive comparison GUI 675, which may include such information as competitive vehicle picture 674, competitive vehicle model 676, competitive vehicle price, and competitive vehicle gas mileage 677. Competitive comparison GUI 675 may further display comparison characteristics of the competitive vehicle such as relative safety 678 and consumer comparison 679. As one of ordinary skill in the art will appreciate with the benefit of this disclosure, other comparison characteristics may be displayed about the competitive vehicle as designated by, for instance, the retailer.

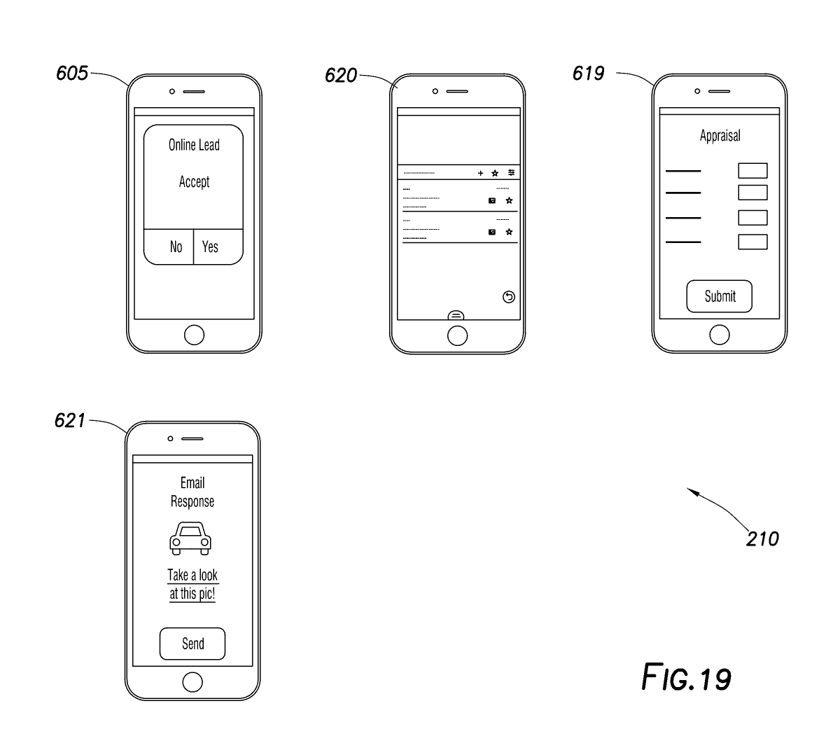

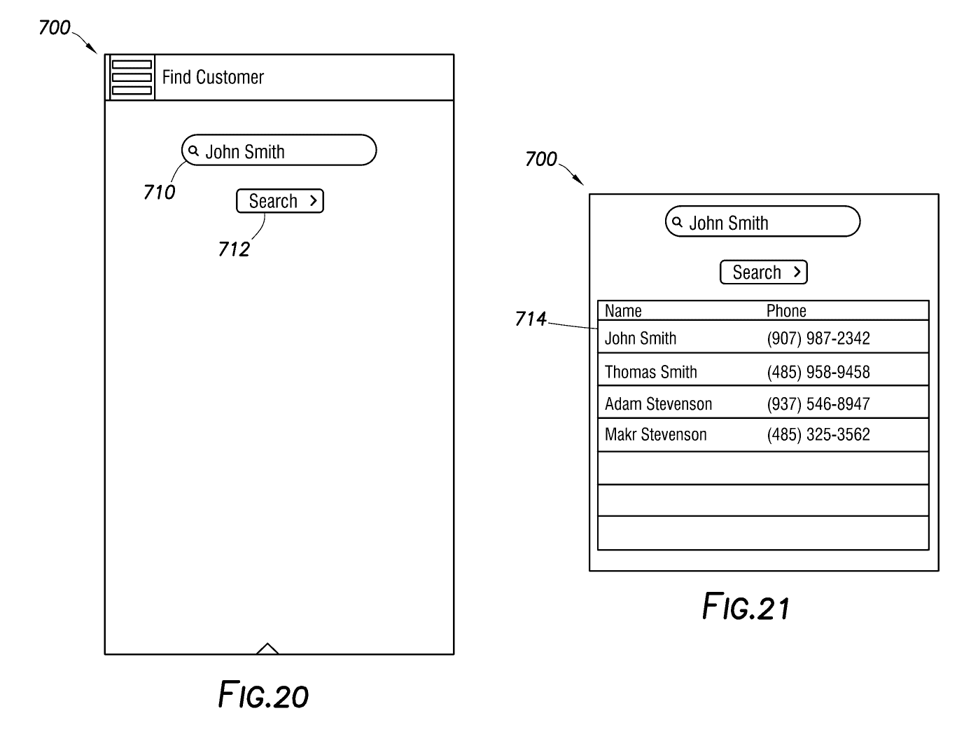

FIG. 19 is a storyboard depiction of receive lead from customer processes 210. The salesperson may receive notification on his mobile computing device of a customer lead through lead notification GUI 605. If accepted by the salesperson, the salesperson may investigate the customer lead by determining what vehicles in the retailer inventory may meet the customer lead's request through vehicle select GUIs 600, 610, 620, 630. Further, the salesperson may obtain an appraisal of the customer's potential trade-in vehicle through trade-in appraisal GUI 619. Trade-in appraisal GUI 619 may accept such information input by the salesperson as trade-in make, model, year, mileage, accessories, and condition. Mobile showroom may then query an appraisal database, which may return an appraisal of the trade-in value of the on-line customer's potential trade-in appraisal GUI. Mobile showroom may advise the salesman that the appraisal of trade-in value is an estimate and is not final. The salesperson may, based on the information determined through vehicle select GUI 600 and/or trade-in appraisal GUI 619, contact the customer in contact customer 621 in response to receive lead from customer processes 210.

Mobile showroom may contain functionality to address customer visits showroom processes 220, referred to hereinafter as a “walk-in.” This functionality is represented in FIG. 2 as meet and greet processes 230. In meet and greet processes 230, the salesperson or other retailer employee may attempt to gather information regarding the walk-in customer. In some embodiments, mobile showroom will not allow the salesperson or other retailer employee to proceed with additional functional steps of mobile showroom until some information about the walk-in customer is entered. In certain instances, the customer may not provide a name, such as in no name collected 232. When the customer does not provide a name, the salesperson may enter into mobile showroom that the customer refused to provide a name or a physical description or other characteristics regarding the walk-in customer. When the walk-in customer does provide a name, the salesperson may determine if the walk-in customer is in the retailer's prospect database, i.e., potential customers that have had previous contact with the retailer or the retailer's original equipment manufacturer (“OEM”). In certain embodiments, the retailer's prospect database and mobile showroom's interactions with the retailer's prospect database as described in U.S. application Ser. No. 14/968,443 filed Dec. 14, 2015, which is incorporated fully be reference herein.

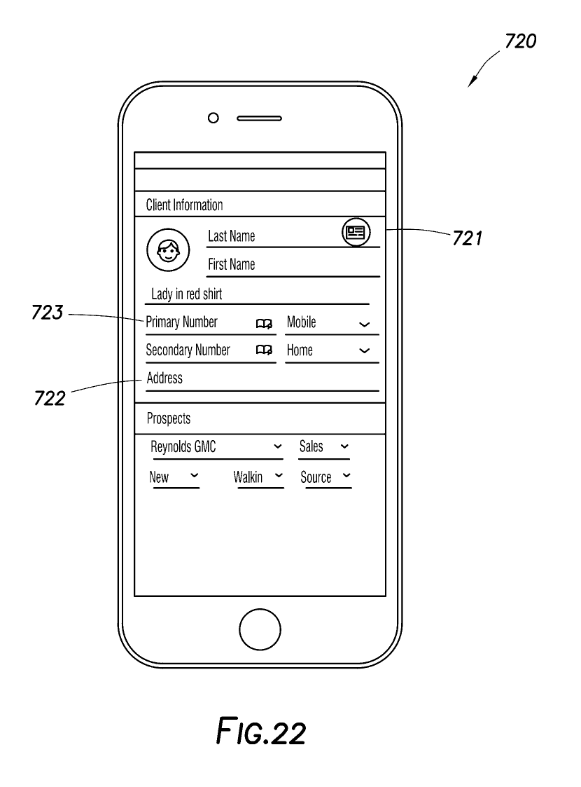

In certain embodiments, the salesperson may determine if the name given by the walk-in customer is in the retailer's prospect database by querying the retailer's prospect database for the name given by the walk-in customer, such as through find customer GUI 700 as shown in FIG. 20. By entering the walk-in customer's name in customer search 710 and selecting customer name search 712, the salesperson may query the retailer's prospect database through the mobile computing device. The query of the retailer's prospect database may return customer results GUI 714 as shown in FIG. 21. Customer results 714 may be limited to the exact name entered by the salesperson through customer search 710, or may, as shown in FIG. 21, show names from the retailer's prospect database that share common characteristics with the name entered by the salesperson through customer search 710.

If the walk-in customer is not in the retailer's prospect database, the walk-in customer may be added, as shown in FIG. 2, add customer name 234, through, for instance, add new prospect GUI 720 as shown in FIG. 22. Add new prospect GUI 720 may allow the salesperson to enter information related to the walk-in customer including name 721, address 722, phone number 723, and email. Information may be typed into add new prospect GUI 720 by the salesperson, or entered by handwriting on the mobile computing device and subsequently transcribed by the mobile computing device. As shown in FIG. 2, the driver's license of the walk-in customer may be added to the retailer's prospect database through driver's license capture 236. The mobile computing device may allow the salesperson to scan the walk-in customer's driver's license in a scan driver's license interface and/or add a picture of the walk-in customer through an add picture interface. Once the information about the walk-in customer is entered into add new prospect GUI 720, the retailer's prospect database may be updated.

With further reference to FIG. 2, if the walk-in customer is determined by the salesperson to be in the retailer's prospect database, the salesperson may determine if the walk-in customer is a vehicle demonstration customer, i.e., demo appointment customer 238. If the walk-in customer is a vehicle demonstration customer, mobile showroom prompts the salesperson to begin vehicle presentation and demo processes 400, further shown in FIG. 4. If not, mobile showroom may determine if the salesperson is new or an average or below average salesperson in salesperson experience determination 240. If the mobile showroom determines that the salesperson is new, average or below average, mobile showroom through the mobile computing device, may prompt the salesperson to access consultative sales process 300, as further shown in FIG. 3. If the salesperson does not qualify as new, average, or below average, mobile showroom may prompt the salesperson to begin vehicle presentation and demo processes 400. In other embodiments, all salespersons may be prompted by mobile showroom to begin vehicle presentation and demo processes 400. In yet other embodiments, begin vehicle presentation and demo processes 400 may be declined by the salesperson.

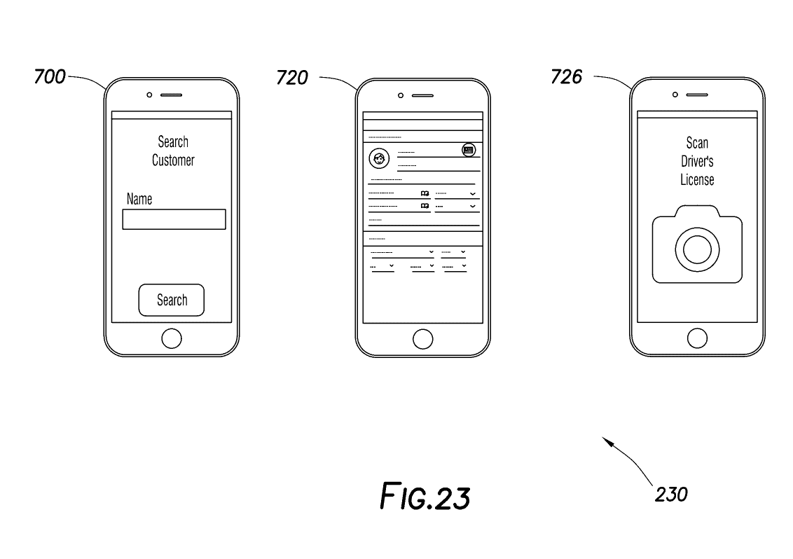

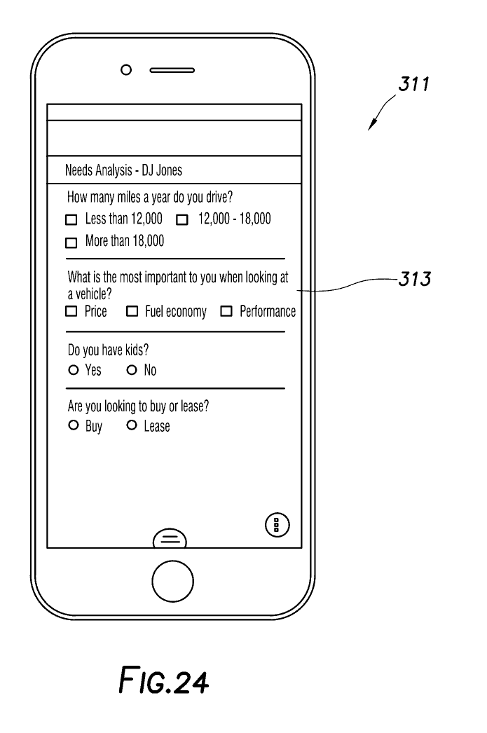

FIG. 23 is a storyboard depiction of meet and greet processes 230. The salesperson may search for the customer in the retailer prospects database through find customer GUI 700. In the event the walk-in customer is not in the retailer prospects database, the salesperson may add the walk-in customer to the retailer prospects database through add new prospect GUI 720. If the walk-in customer's driver's license is not already captured in the retailer prospects database, the salesperson may capture the driver's license through scan driver's license interface 726.

FIG. 3 is a block diagram of consultative sales process 300. Consultative sales process may include needs analysis 310 and search vehicle inventory 330. Needs analysis 310 may include questionnaire 313. In certain embodiments, the questions in questionnaire 313 may be determined by the retailer. The questionnaire may be a preset form with questions that are yes/no questions or select options-type questions, as shown in needs questionnaire GUI 311 in FIG. 24. In some embodiments, no typing is required by the salesperson to complete questionnaire 313. When prompted by mobile showroom or selected by the salesperson, mobile showroom may show on the mobile computing device a questionnaire. The salesperson may ask the customer, such as a walk-in customer, the questions from the questionnaire. Questionnaire 313 may be executed by the salesperson through needs analysis GUI 310. Non-limiting examples of needs analysis questions, as shown in FIG. 24, may include miles driven per year, important aspects of the vehicle, number of kids, and preference on buy or lease.

Needs analysis 310 may further include a dealer introduction video. When prompted by mobile showroom or selected by the salesperson, mobile showroom may show on the mobile computing device a dealer video introduction for viewing by the customer. The dealer video introduction may be a short video, where the retailer introduces itself and may explain why the customer should purchase a vehicle from the retailer.

Needs analysis 310 may further include notes section 318. When prompted by mobile showroom or selected by the salesperson, mobile showroom may allow the salesperson to take any notes regarding the needs analysis session with the potential customer. In certain embodiments, the notes may be handwritten. When the notes are handwritten, the notes may be transcribed by functionality in the mobile computing device, or saved as an image by the mobile computing device.

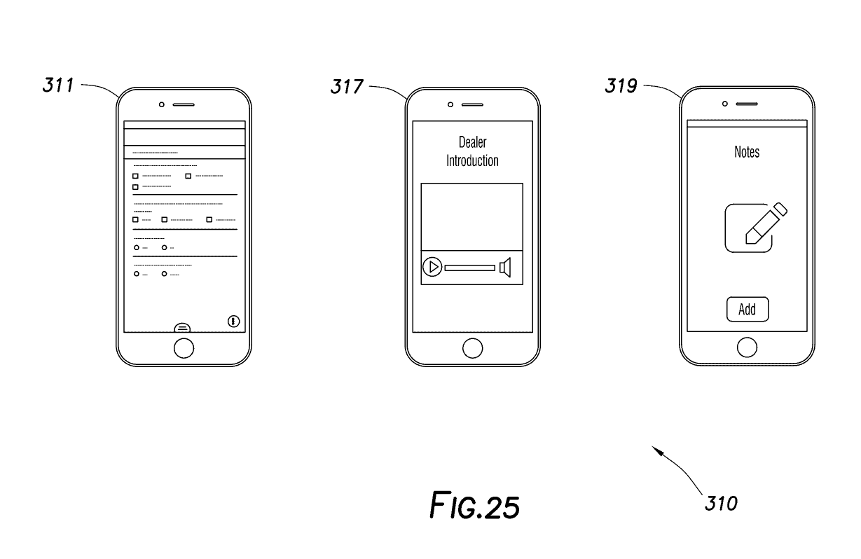

FIG. 25 is a storyboard depiction of needs analysis 310. As shown in FIG. 25, the salesperson may use the mobile computing device with a preset questionnaire to ask the customer, such as a walk-in customer, questions selected through the retailer through needs analysis GUI 310. The salesperson may further show a retailer introduction video through dealer introduction video GUI 315. In addition, the salesperson may take notes on the needs analysis process through notes GUI 318.

When prompted by mobile showroom or selected by the salesperson, mobile showroom may allow the salesperson to search the retailer's vehicle inventory in search vehicle inventory 330, as shown in FIG. 3. For instance, based on results from the questionnaire (313), certain vehicle characteristics may be selected by mobile showroom for search vehicle inventory 330. Search vehicle inventory may include select vehicle process 335. When a customer, such as a walk-in customer has already selected the vehicle, the salesperson may proceed to vehicle presentation and demo processes 400. Where the customer has not yet selected a particular vehicle, mobile showroom may prompt the salesperson through select vehicle process 335. Select vehicle process 335 may include selecting the vehicle, introducing dealer specials, rebates and incentives 336 to the customer, providing similar vehicle comparisons 337, and discussing competitive model comparisons 338. The process of the select vehicle process 335 may be as described above with respect to FIGS. 14-16A and vehicle select GUIs 600, 610, 620, 630.

As further depicted in FIG. 3, the salesperson may notify a retailer manager that assistance is needed in SOS 350.

FIG. 4 is a block diagram of vehicle presentation and demo processes 400. Vehicle presentation and demo processes 400 may include vehicle walkaround process 410, demo drive process 450, and trade appraisal process 470. Vehicle walkaround process may be directed to assisting the salesperson in describing vehicle features and options while viewing a vehicle that the customer has selected.

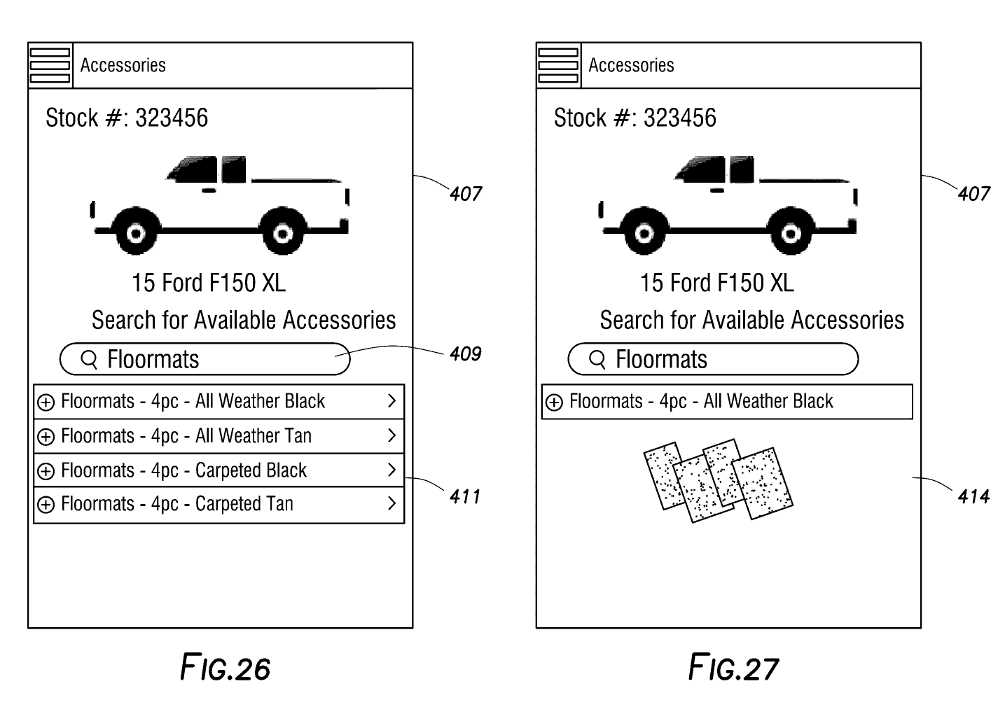

In the embodiment depicted in FIG. 4, vehicle walkaround process 410 may include accessory lookup process 415. In accessory lookup process 415, mobile showroom may assist the salesperson in describing accessories that may be added to the vehicle selected by the customer. The salesperson may query an accessories database through the mobile computing device, such as through search accessories GUI 407 as shown in FIG. 26. In the example depicted in FIG. 26, the salesperson has selected floor mats as an accessory in accessory search field 409 in search accessories GUI 407. By querying the accessories database, mobile showroom may determine what accessories are associated with the term in accessory search field 409 and may specify the results of the query as accessory results 411. In the example shown in FIG. 26, the term floor mats has returned accessory results 411 of different types of available floor mats. By selecting a particular accessory of accessory results 411, the salesperson may, through the mobile computing device, retrieve from the accessories database, additional accessory information 414 through search accessories GUI 407 as shown in FIG. 27. In certain embodiments, accessory lookup process 415 may be conducted as described in U.S. application Ser. No. 15/287,350, filed Oct. 6, 2016, which is incorporated fully be reference herein.

Vehicle walkaround process 410 may further include obtain key for vehicle process 420. In certain embodiments, the salesperson may use the mobile computing device to scan a barcode for the passcode to get a key from a key control device for the vehicle the customer has selected. In certain embodiments, the barcode may correspond to the VIN of the vehicle the customer has selected.

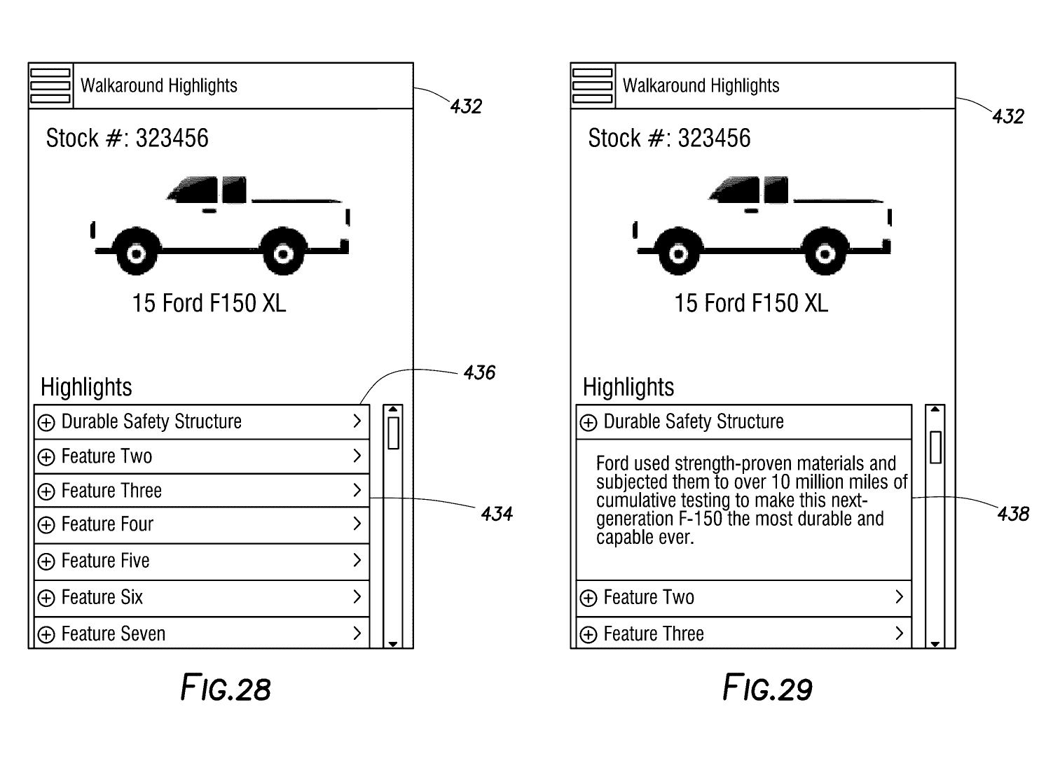

Vehicle walkaround process 410 may further include present features process 430. In present features process 430, mobile showroom may assist the salesperson by depicting on the mobile computing device specific predetermined features of the make and model of the vehicle that the customer has selected. In some embodiments these features may be selected by the retailer. By specifying the vehicle, the salesperson may obtain, for instance, through walkaround highlights GUI 432 as shown in FIG. 28, the predetermined features of the vehicle the customer has selected. These features are shown in FIG. 28 as features 434. By selecting in mobile showroom a particular predetermined feature, i.e, predetermined feature 436, the salesperson may obtain additional information about predetermined feature 436, i.e. feature information 438, as shown in FIG. 29.

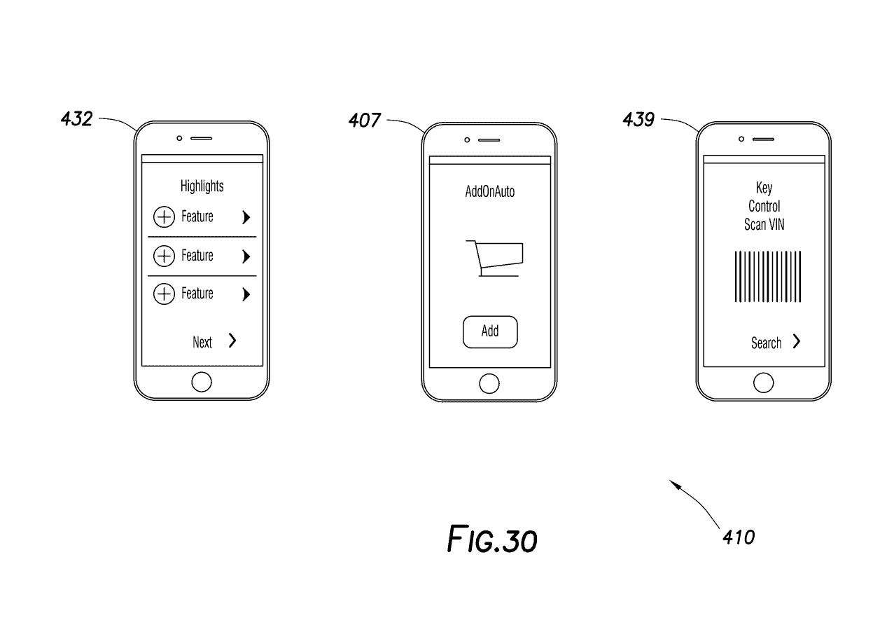

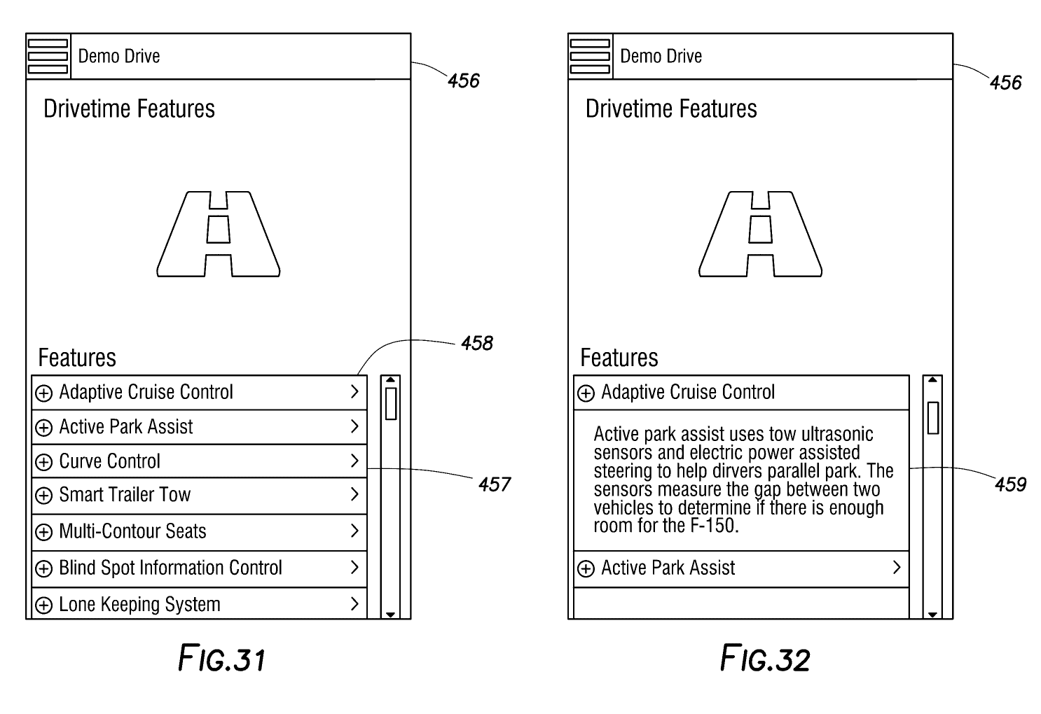

FIG. 30 is a storyboard depiction of vehicle walkaround process 410. The salesperson may access walkaround highlights GUI 432 to highlight features of the vehicle that the customer has selected. The salesperson may also determine accessories that are available for the vehicle the customer has selected through search accessories GUI 407. In addition, the salesperson may obtain a key for the vehicle the customer has selected through scan barcode GUI 439.

Where a customer wishes to conduct a test drive, mobile showroom includes demo drive processes 450 as shown in FIG. 4 to assist the salesperson. Demo drive processes 450 may include present demo features process 455. Mobile showroom may assist the salesperson by depicting on the mobile computing device specific predetermined features of the make and model of the vehicle that the customer has selected that may be demonstrated during the test drive. In some embodiments these features may be selected by the retailer and/or the OEM. By specifying the vehicle, the salesperson may obtain, for instance, through demo drive highlights GUI 456, the predetermined features of the vehicle the customer has selected. These features are shown in FIG. 31 as demo drive features 457. By selecting in mobile showroom a particular predetermined feature, i.e, predetermined demo drive feature 458, the salesperson may obtain additional information about predetermined demo drive feature 458, i.e. feature information 459, as shown in FIG. 32.

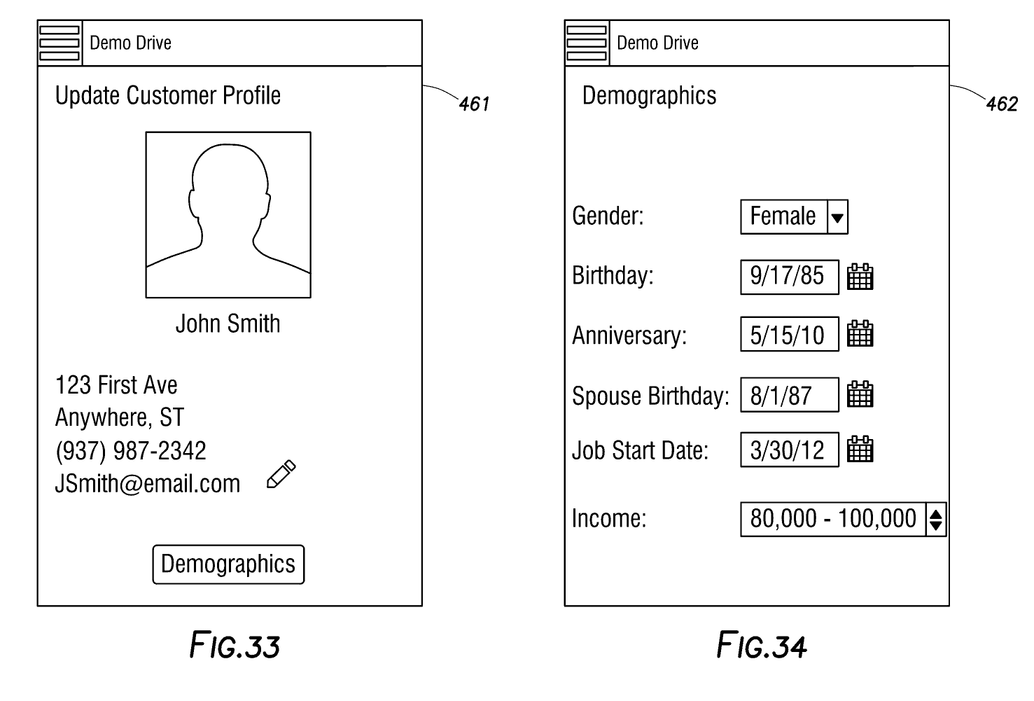

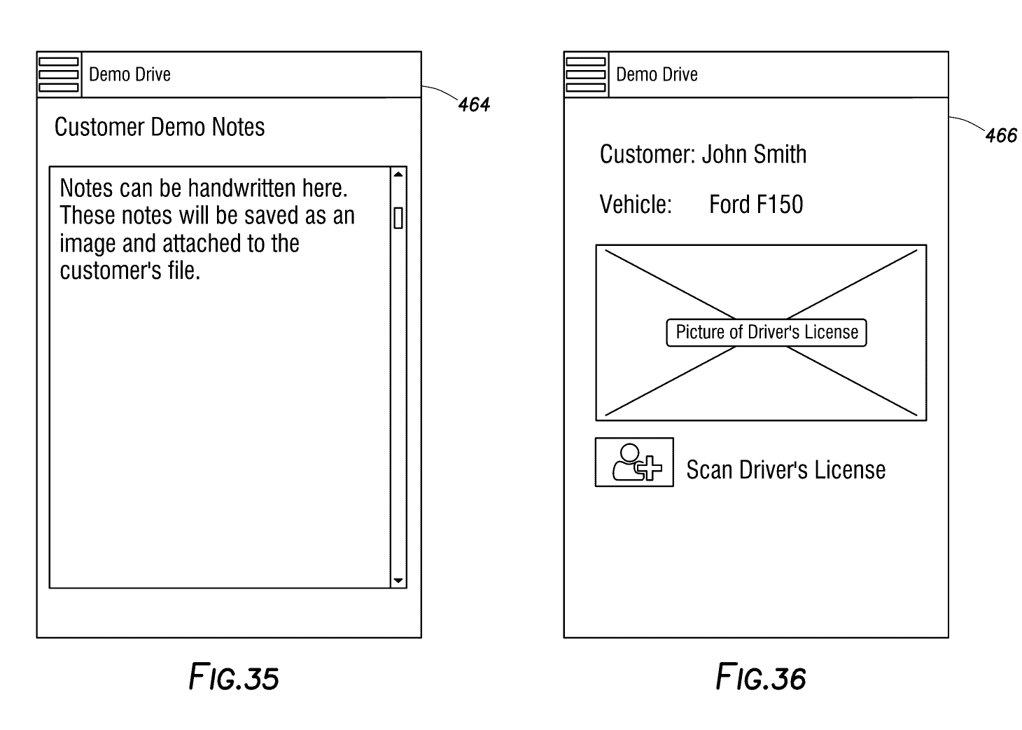

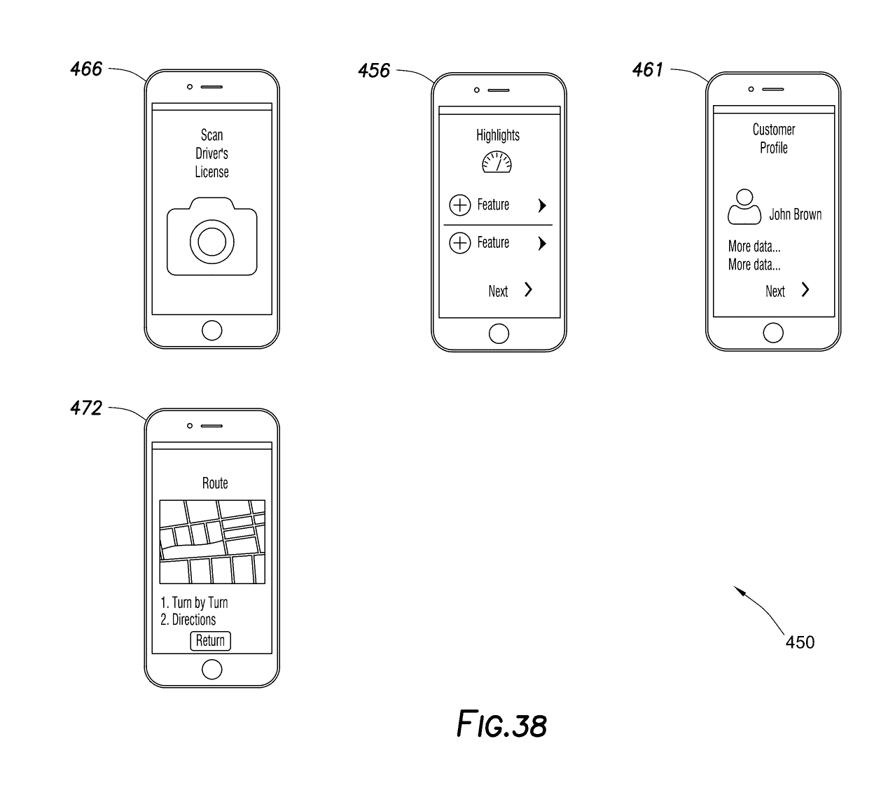

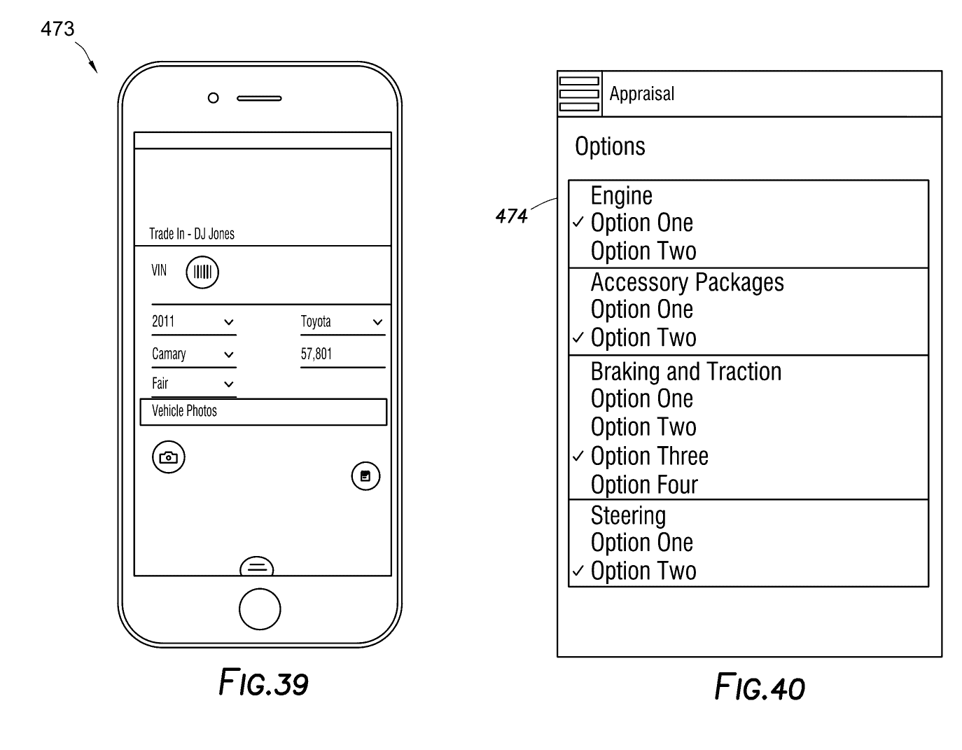

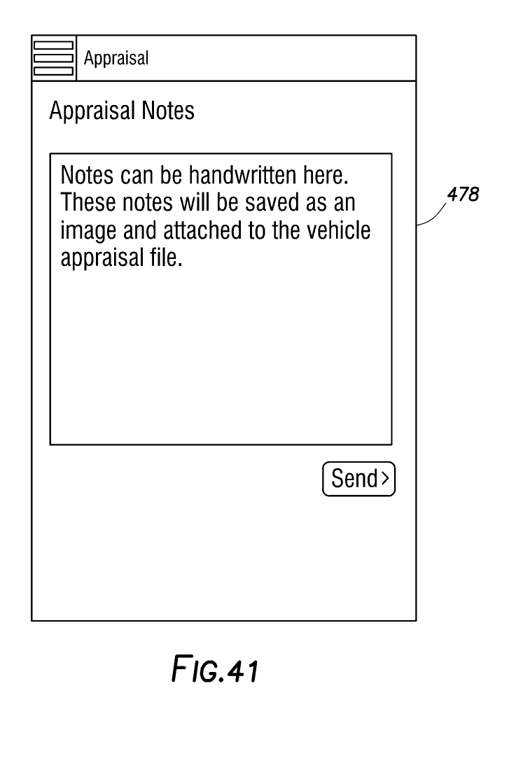

Another of demo drive process 450 may be update customer profile 460. While the customer is engaged in the test drive, the salesperson may use mobile showroom to capture additional information about the customer through update customer profile GUI 461, as shown in FIG. 33. Information that may be entered through update customer profile GUI 461 may include address, phone number, and e-mail. In addition, the salesperson may gather demographics information about the customer during the test drive through customer demographics GUI 462, as shown in FIG. 38. Demographics information collected through customer demographics GUI 462 may include gender, birthday, anniversary, spouse's birthday, job start date and income level, as shown in FIG. 38. Update customer profile 460 may also include any notes captured by the salesperson about the customer through, for instance, customer demo notes GUI 464, as shown in FIG. 35.

Another of demo drive process 450 may be driver's license capture 465. Prior to the test drive, for instance, mobile showroom may prompt the salesperson to request a copy of the customer's driver's license. The driver's license may be captured and stored by mobile showroom by scanning the customer's driver's license through demo drive license capture GUI 466, as shown in FIG. 36.

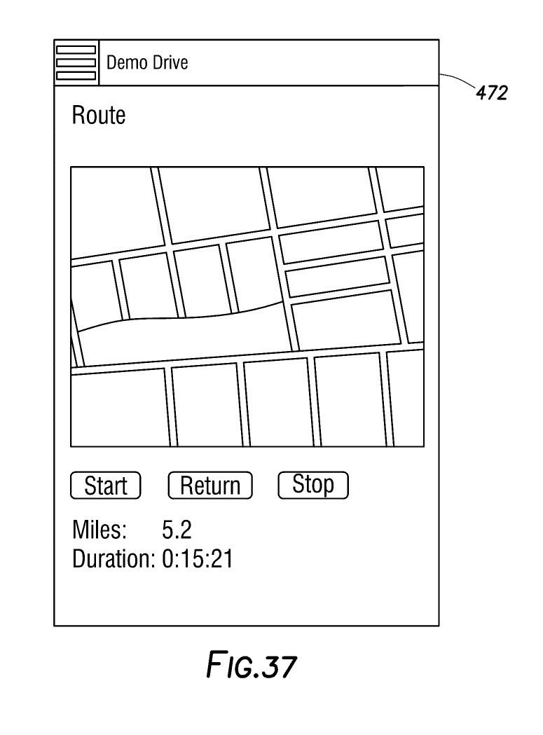

Yet another of demo drive process 450 may be display GPS enabled route 472. Mobile showroom may have stored alternate test drive routes that may be selected by mobile showroom, the salesperson, or a combination of mobile showroom and the salesperson based on such factors as make and model of the vehicle, time of day, traffic patterns, or customer preference. In some embodiments, the test drive route may be a standard route for the retailer. The test drive routes may be displayed through GPS enabled route GUI 472, as shown in FIG. 37. In certain embodiments, the test drive routes may be GPS enabled in that GPS enabled route GUI 472 may signal the salesperson at certain GPS waypoints provide turn by turn directions, or may show the vehicle's location on a map.

In certain embodiments, demo drive processes 450 may include selecting word tracks for the salesperson during the vehicle demonstration to better bond with customers. Mobile showroom may offer specific word tracks, based on, for instance, the make and model of the vehicle, information about the customer, or the particular salesperson. These word tracks may be displayed on the mobile computing device.

FIG. 38 is a storyboard depiction of demo drive processes 450. The salesperson may scan the customer's driver's license through demo drive license capture GUI 466. The salesperson may review specific predetermined features of the make and model of the vehicle that the customer has selected that may be demonstrated during the test drive through demo drive highlights GUI 456. During the test drive, the salesperson may gather additional information about the customer through update customer profile GUI 461. In addition, the salesperson may obtain test drive routes for demonstrating the vehicle to the customer through GPS enabled route GUI 472.

With further direction to FIG. 4, trade appraisal process 480 may include functionality in mobile showroom to allow the salesperson to work with other retailer employees to price the customer's trade-in vehicle. In certain embodiments, trade appraisal process may be performed in accordance with estimate trade-in step as shown in U.S. application Ser. No. 15/285,524, filed Oct. 4, 2016, incorporated fully be reference herein. In other embodiments, for instance, as shown in FIG. 39, basic information about the customer's trade-in vehicle such as VIN, Make, model, and mileage may be input by the salesperson through basic appraisal GUI 473. In certain embodiments, digital photographs may be taken and uploaded through mobile computing device as shown in FIG. 39. Additional information about the customer's trade-in vehicle, such as information about the vehicle engine, accessory packages, braking and traction, steering, or other information relevant to the value of the customer's trade-in vehicle may be input by the salesperson into mobile showroom through features appraisal GUI 474 as shown in FIG. 40. In addition, as shown in FIG. 4, the salesperson may capture photos of the trade-in through capture trade-in photos process 471. Notes the salesperson has regarding the customer's trade-in vehicle may be input to mobile showroom through appraisal notes GUI 478, as shown in FIG. 41. Information obtained through basic appraisal GUI 473, features appraisal GUI 474, capture trade-in photos process 471, and appraisal notes may be used in estimate trade-in step as shown in U.S. application Ser. No. 15/285,254, filed Oct. 4, 2015, incorporated fully be reference herein.

The information gathered about the customer's trade-in vehicle in trade appraisal process 470 may be sent via mobile showroom to an employee of the retailer who may appraise the customer's trade-in vehicle, often the used vehicle manager, in used vehicle management process 477 or as described in U.S. application Ser. No. 15/285,254, filed Oct. 4, 2016, incorporated fully be reference herein. The used vehicle manager may communicate the appraisal of the customer's trade-in vehicle to the salesperson's mobile computing device through mobile showroom, may provide the appraisal to salesperson's manager, or both.

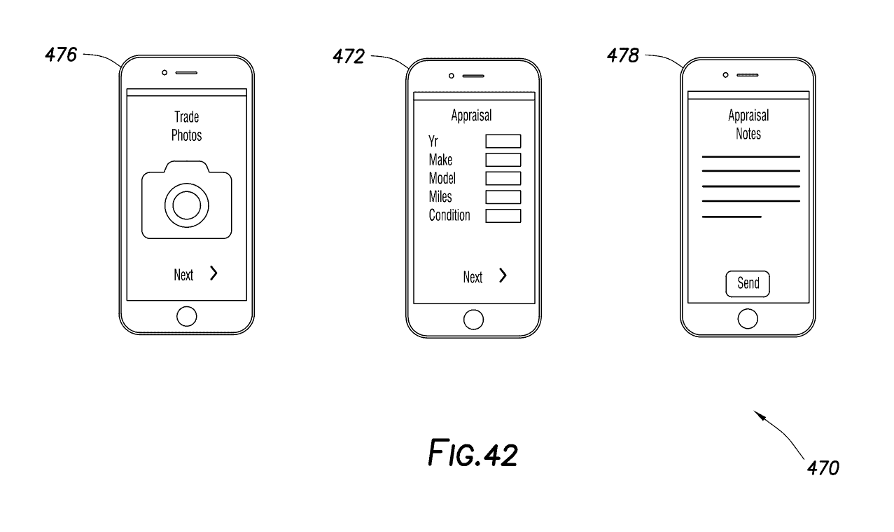

FIG. 42 is a storyboard depiction of trade appraisal process 470. The salesperson may capture photos of the customer trade-in vehicle through trade-in photo GUI 476. The salesperson may input information related to the trade-in vehicle through basic appraisal GUI 473. In addition, the salesperson may take notes regarding the customer's trade-in vehicle through appraisal notes GUI 478.

With further attention to FIG. 4, information from trade appraisal process 470, used vehicle management process 477, and demo drive processes 450 may be communicated to, for instance, a manager, in negotiation process 490. In certain embodiments, negotiation process 490 may include the use of a negotiation system. An example of an online negotiation system that may be used in negotiation process 490 is described in U.S. application Ser. No. 62/061,006,which is fully incorporated by reference. Mobile showroom may support the negotiation system by providing the salesperson with write up functionality, i.e., process for vehicle information pull up, credit application and optional initial offers with multi-choice or single-choice options. Mobile showroom may also include negotiation functionality, such as providing process to adjust price, payment, interest rate, and trade-in value figures in the offer. In addition, mobile showroom may allow the salesperson to close the deal through an acceptance button and next steps word tracks.

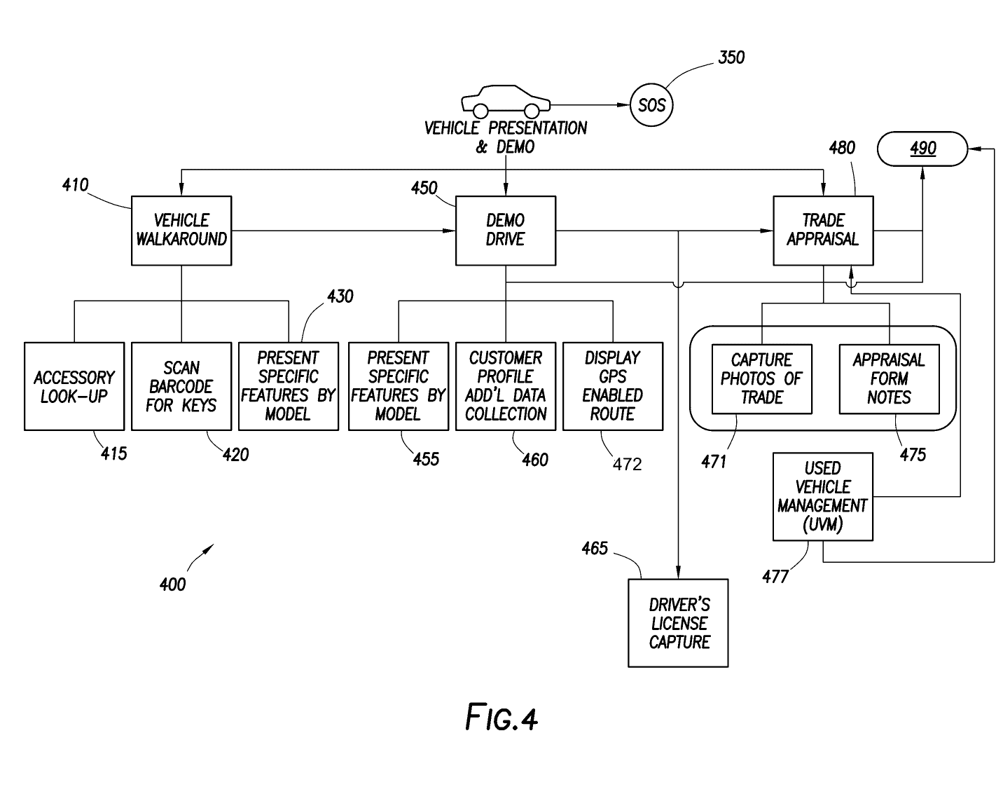

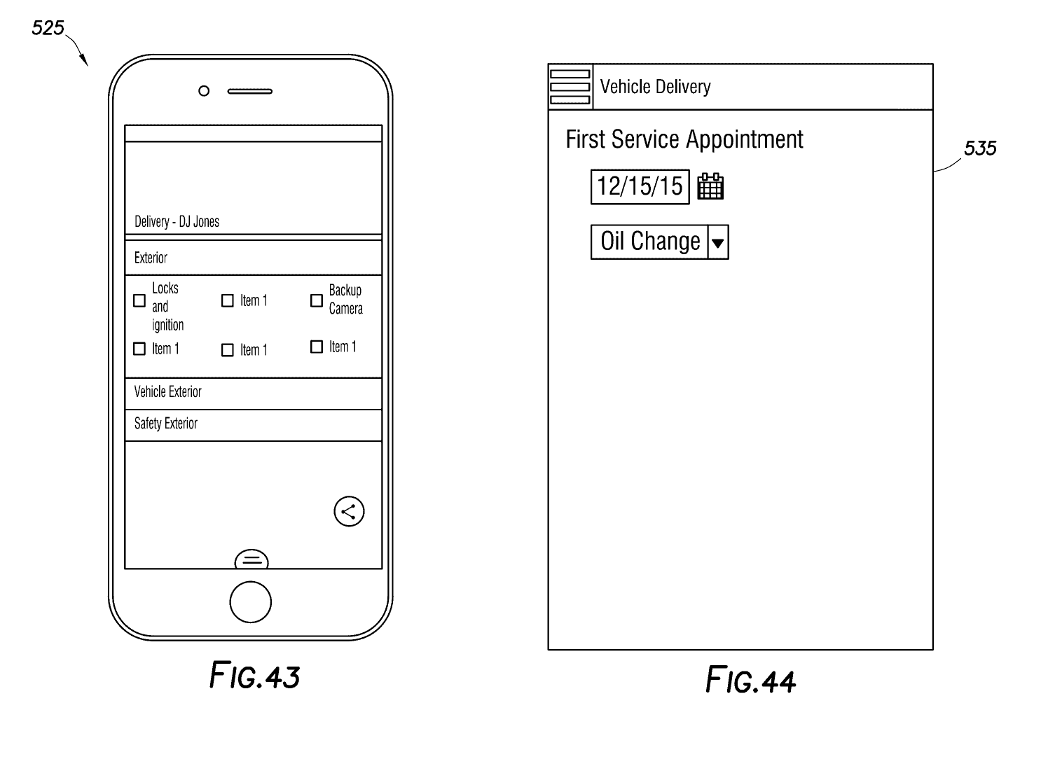

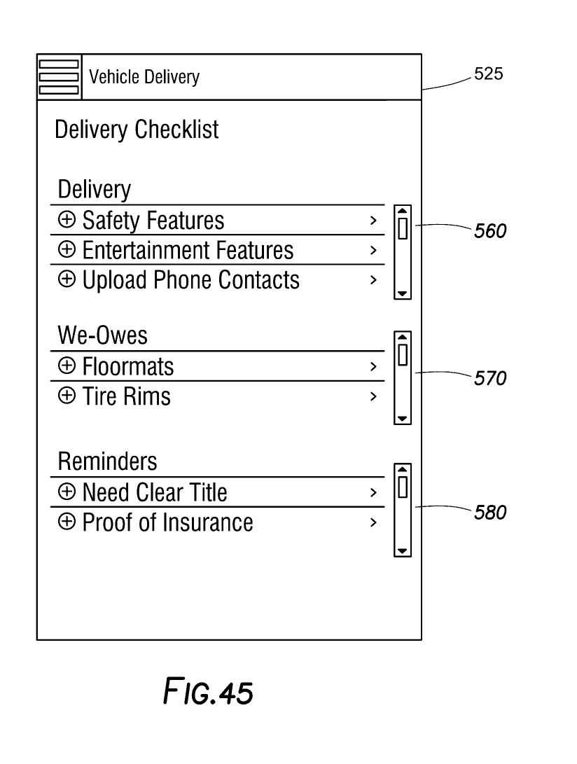

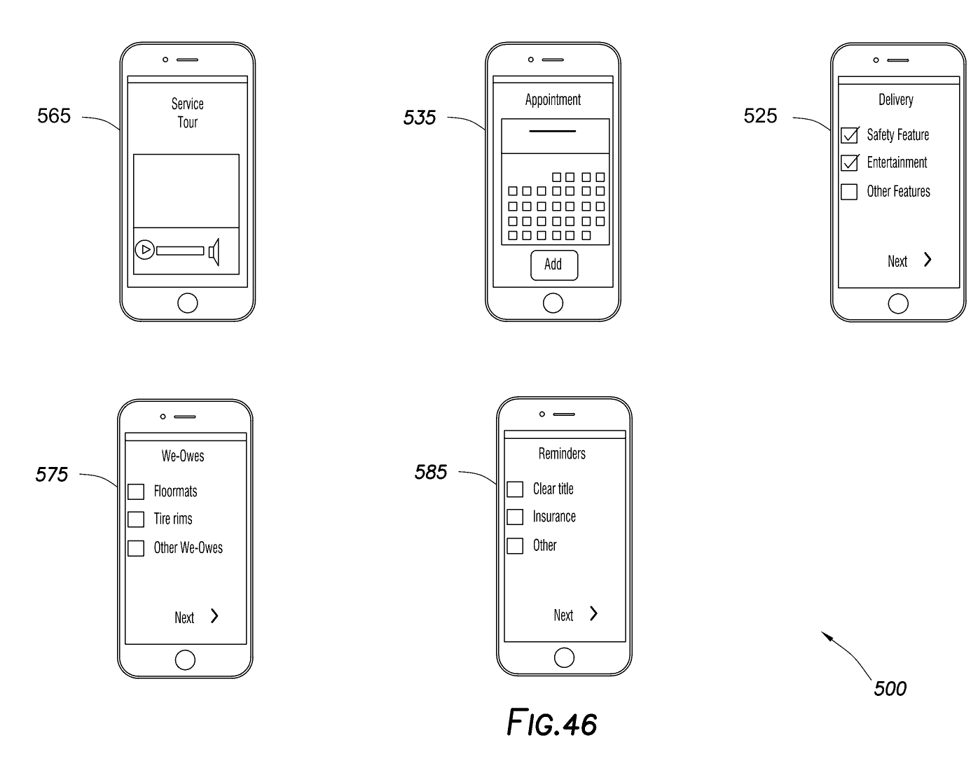

FIG. 5 depicts post desking and/or F&I processes 500 that may be available through mobile showroom. Post desking and/or F&I processes 500 may include service introduction processes 510, directed to introducing the customer of a purchased vehicle to the service department of the retailer. In certain embodiments service introduction processes 510 may include virtual tour of service 520 and schedule first appointment 530. In some embodiments, service introduction processes 510, and vehicle delivery processes 550 (described hereinbelow) may be performed prior to F&I processes. In virtual tour of service 520, mobile showroom may offer the salesperson a service department video that can be shown to the customer that presents dealer specific features and/or a tour of the service department and the service department processes. As shown in FIG. 43, as part of the delivery process, delivery checklist GUI 525 may be used. In schedule first appointment 530, as shown in FIG. 44, the salesperson may work with the customer to schedule the customer's first appointment with the service appointment. Schedule first appointment 530 may be accessed from mobile showroom through first service appointment GUI 535. Through first service appointment GUI 535, the salesperson may, through the mobile computing device, access a database of service appointments and thereby schedule an appointment with the service department for the customer.

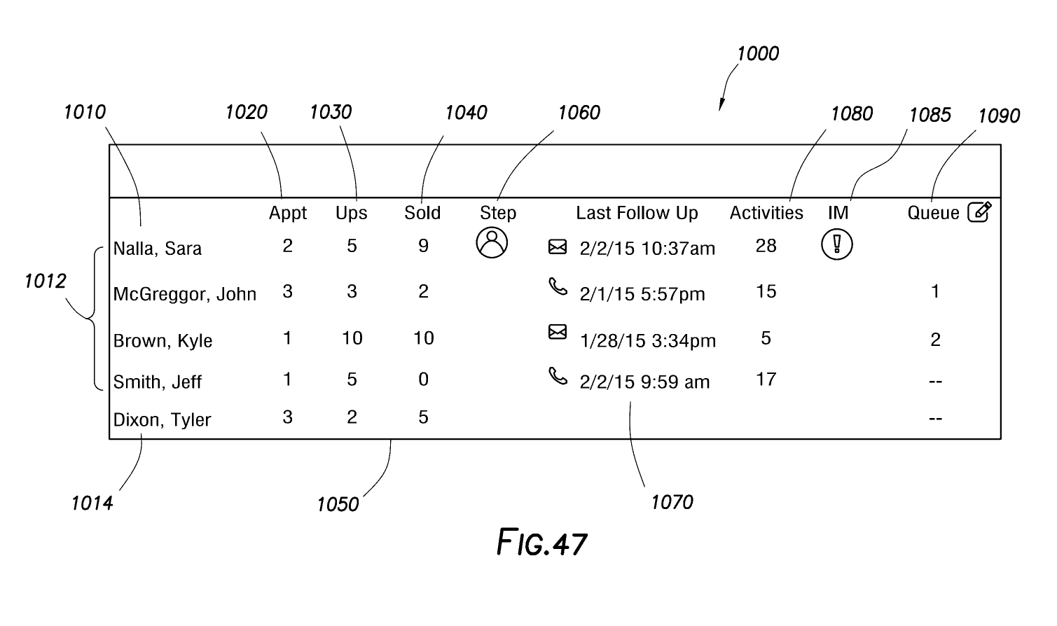

With further direction to FIG. 5, post desking and/or F&I processes 500 may further include vehicle delivery processes 550. Vehicle delivery processes 550 may include delivery checklist 560, we-owes 570, and slips reminders 580. Delivery checklist 560 may include a dealer-defined checklist for the salesperson to discuss with the customer that describes basic functionality on how to operate various functions of the vehicle purchased by the customer. We-owes 570 may display a list of items, such as accessories, that are part of the deal between the customer and the retailer that have yet to be delivered by the retailer. Slips reminders 580 may display for the customer outstanding tasks that the customer may need to perform to support the deal between the customer and the retailer regarding the vehicle purchased by the customer. Mobile showroom may depict delivery checklist 560, we-owes 570, and slips reminders 580 on delivery checklist GUI 525, as shown in FIG. 45.

FIG. 46 is a storyboard depiction of post desking and/or F&I processes 500. The salesperson may display a video regarding the retailer service department through service virtual tour GUI 565. The salesperson may assist the customer in making the customer's first service appointment for a purchased vehicle through first service appointment GUI 535. In addition, salesperson may review a dealer-defined list of delivery items, such as how various functions of the purchased vehicle operate, through delivery checklist GUI 525. The salesperson may also review a checklist of items still owed the customer by the retailer through we-owes GUI 575. The salesperson may, in addition, review with the customer any issues the customer may need to address through slips GUI 585.

In certain embodiments of the present disclosure, mobile showroom may administer vehicle information courses and tests, selling courses and tests, company protocols and tests, HR information and tests on the mobile computing device, either when selected by the salesperson, directed by a sales manager, or directed by mobile showroom.

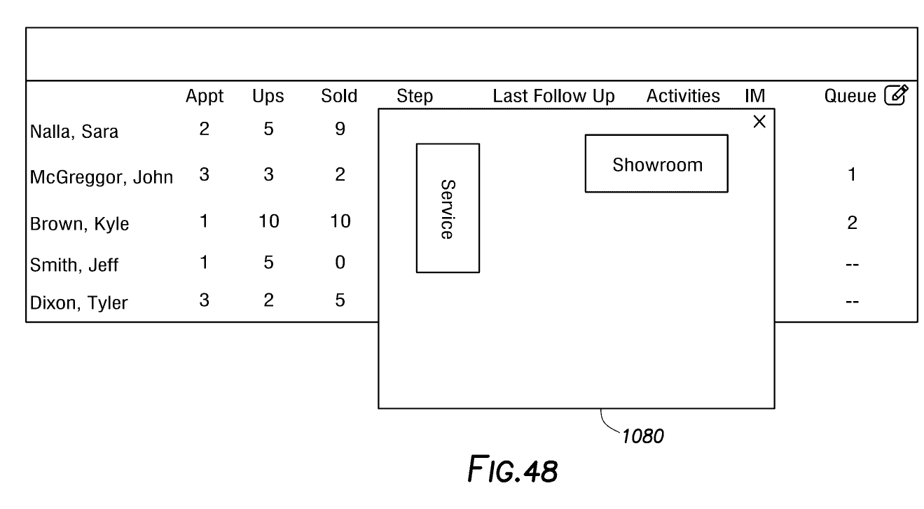

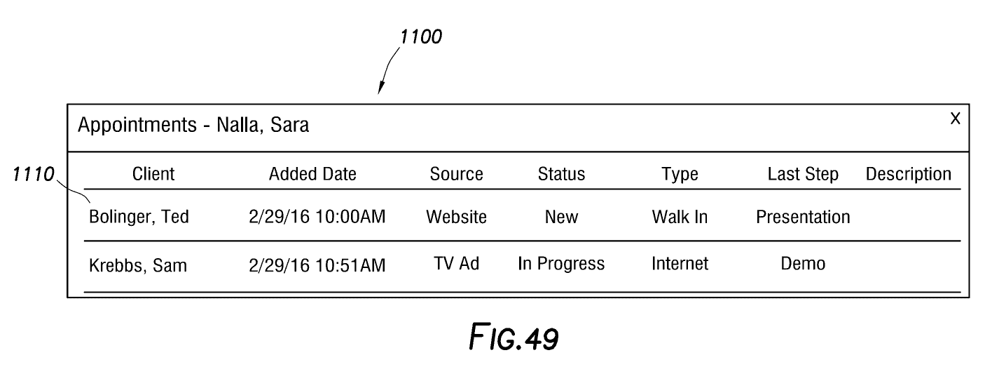

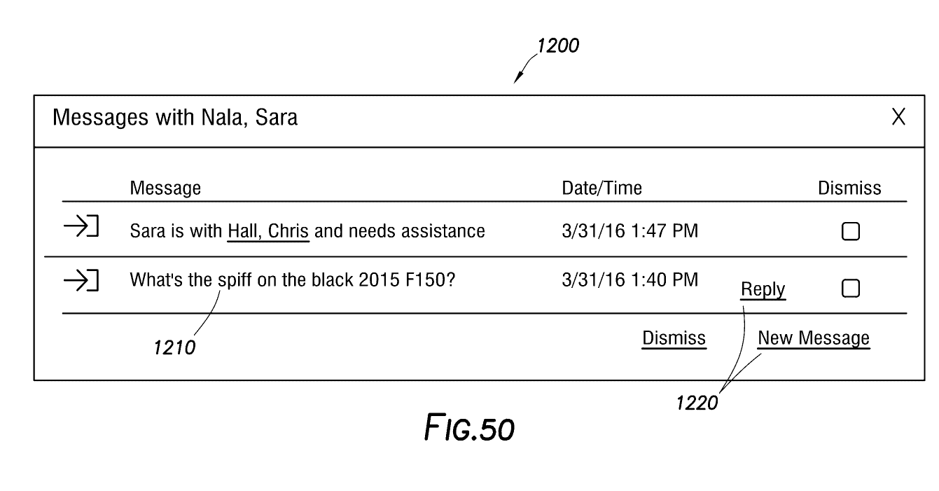

In certain embodiments of the present disclosure, mobile showroom may allow an employee other than a salesperson, such as a sales manager, access to different functionality and processes than are available to salespersons. For instance, in certain embodiments of the present disclosure, the mobile showroom may, through a mobile computing device, display manager dashboard 1000 as shown in FIG. 47. In certain embodiments, display manager dashboard includes manager dashboard GUI 1050, which may allow interaction between the sales manager and the dashboard entries. Examples of information displayed on display manager dashboard may include salespersons 1010. In certain embodiments, manager dashboard GUI 1050 may provide the status of the salesperson as either checked-in to mobile showroom or checked out of mobile showroom. For instance, as shown in FIG. 47, salespersons that are checked in to mobile showroom (checked in salespersons 1012) may be designated in a different font, color, or background as salespersons not checked-in to mobile showroom (checked out salesperson 1014). Manager dashboard GUI 1050 may also depict s number of appointments for today 1020 for one or more salespersons, ups assigned to salesperson 1030, and vehicles sold by salesperson per time period 1040. The process being used in mobile showroom by the salesperson may be depicted on manager dashboard GUI 1050 (step 1060). The last follow up activity by the salesperson on his daily workplan may be displayed on last follow up 1070 and the number of items in the daily workplan may be displayed as activities 1080. Manager dashboard GUI 1050 may also display up status queue status 1090. By interacting with mobile showroom via manager dashboard GUI 1050, the manager may obtain additional information about individual salespersons, as shown in FIG. 49 in additional information field 1110 in salesperson pop-up GUI 1100. As another example, as shown in FIG. 48, by selecting an individual salesperson from checked in salespersons 1012, manager dashboard GUI 1050 may display salesperson location, i.e., the location of the salesperson on the retailer property. As shown in FIG. 50, in certain embodiments, messages to the sales manager (1210) may be viewed by the manager or new message sent by the sales manager (1220) either as a new message or as a reply to an existing message as shown in message pop-up GUI 1200. In certain embodiments, message pop-up GUI 1200 may be accessed by selecting message button 1085, as labelled “IM” in FIG. 47.

Other functionality that may be available to the sales manager through the mobile showroom may include communications tool processes to communicate to individual salespersons through mobile showroom, updates regarding offers during deal negotiations, such as during negotiation process 490, and information regarding trade appraisals, such as during trade appraisal process 470.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method comprising:
supplying a mobile computing device to a vehicle salesperson;
checking in to a mobile showroom, wherein checking in to a mobile showroom makes available the vehicle salesperson for ups; and
determining if the vehicle salesperson is assigned an up.

2. The method of claim 1 further comprising:
determining if the salesperson is within a certain geographical area.

3. The method of claim 1, wherein the step of determining if the vehicle salesperson is assigned an up is made by a rules engine, wherein the rules engine considers vehicle salesperson's check-in time, ranking of the salesperson, and task eligibility or selects via round-robin.

4. The method of claim 3, wherein the method further comprises using a shot clock, the shot clock determining if an assignment is retained.

5. The method of claim 1 further comprising:
viewing a sales motivation board on the mobile computing device.

6. The method of claim 1 further comprising viewing a daily workplan on the mobile computing device.

7. The method of claim 1 further comprising:
receiving a customer lead through the mobile computing device.

8. The method of claim 7 further comprising:
searching vehicle inventory through mobile computing device and receive a search result vehicle; and
reporting search vehicle through the mobile computing device to the customer lead.

9. The method of claim 7 further comprising:
conducting a trade appraisal of the customer lead's trade-in vehicle; and
reporting the trade appraisal through the mobile computing device to the customer lead.

10. The method of claim 1 further comprising:
determining if a customer to a retailer is in a retailer prospect database; and
if the customer is not in a retailer prospect database, entering information related to the walk-in customer to the retailer prospect database.

11. The method of claim 10, wherein the information related to the customer is customer name, customer address, customer phone number, customer email, or combinations thereof.

12. The process of claim 10 further comprising:
scanning the customer's driver's license into the mobile computing device.

13. The process of claim 1 further comprising showing to a customer a dealer video introduction through the mobile computing device.

14. The process of claim 1 further comprising:
displaying a needs questionnaire on a mobile computing device;
asking a customer questions from the needs questionnaire and obtaining customer answers;
recording the customer answers on the mobile computing device.

15. The method of claim 1 further comprising:
searching retailer vehicle database through a mobile computing device based on vehicle information provided by a customer;
returning a search result vehicle based on the vehicle database search; and
communicating the search result vehicle to the customer.

16. The method of claim 15 further comprising;
searching the retailer vehicle database through a mobile computing device to obtain similar in stock search results; and
communicating the similar in stock search results to the customer.

17. The method of claim 15 further comprising displaying to the customer on a mobile computing device a competitive vehicle to the search result vehicle.

18. The method of claim 1 further comprising:
querying an accessories database through a mobile computing device to determine what accessories are available for a selected vehicle.

19. The method of claim 1 further comprising:
scanning a selected vehicle's VIN with a mobile computing device; and
obtaining a key from a key control device based on the selected vehicle's VIN.

20. The method of claim 1 further comprising:
obtaining from a mobile computing device a test drive route, wherein the test drive route is determined based on make and model of vehicle, time of day, traffic patterns, customer preference, or a combination thereof.

21. The method of claim 1 further comprising:
displaying a delivery checklist to a customer from a mobile computing device;
displaying a list of we-owes to a customer from a mobile computing device; and
displaying slip reminders to a customer from a mobile computing device.
